(19) United States
(12) Patent Application Publication
(10) Pub. No.: US 2012/0050613 A1
(43) Pub. Date: Mar. 1, 2012

(54) Method of synchronization, corresponding system and device

(75) Inventors: TRISTAN HALNA DU FRETAY, RENNES (FR); YACINE SMAIL EL KOLLI, RENNES (FR); LAURENT FROUIN, RENNES (FR)

(73) Assignee: CANON KABUSHIKI KAISHA, Tokyo (JP)

(21) Appl. No.: 13/218,208

(22) Filed: Aug. 25, 2011

(30) Foreign Application Priority Data
Aug. 31, 2010 (FR) 1056914

(51) Int. Cl. H04N 9/475

(52) U.S. Cl. 348/513; 348/E09.034

(57) ABSTRACT

The present invention concerns a method of synchronization between devices of a distribution system for distributing video streams of images.

The system comprises at least three devices, including a sender and a receiver, wherein a sending device is configured to receive, from a source, a video stream presenting a source image frequency, and a receiving device is configured to control the display, at a display frame rate, of a video stream on a display device.

The method comprises obtaining a common target frame rate; adapting, by the devices, a source video stream received from a source, respectively, directly or via a sending device, from the source frame rate to the target frame rate; and adjusting, on each receiver, the display frame rate so as to control a display at said target frame rate.

This application claims priority from French patent application No. 10 56914 of Aug. 31, 2010 which is incorporated herein by reference.

### FIELD OF THE INVENTION

The present invention concerns a method of synchronization between devices of a distribution system for distributing video streams of images.

The present invention generally concerns the field of information and communication technology.

### BACKGROUND OF THE INVENTION

The present invention applies in particular to high-end video display systems with multiple projection. These are audio-visual projection systems constituted by several high definition audio-visual sources adapted to be displayed via one or more projectors or screens. These systems enable the implementation of video display systems of very large size and of very high quality, for example in the open air in a stadium for a sports event or a concert, or in a conference hall.

These multiple projection video systems may also be used for simulators, in order to produce an impression of immersion in the simulated universe, with different screens then forming a continuous surrounding of the user. In such a situation, the images projected edge to edge (or with a slight overlap) on the various screens must be perfectly synchronized to ensure realism.

Another application concerns conference systems, in which one or more large screens are used to project images for example from computers of various participants. The images of certain sources may for example be reduced in size and aligned on one side of the main image, or embedded within it. In this case, the changeover of the sources between the shrunk images and the main image must be carried out rapidly and without visual artifacts, for the comfort of users.

For reasons of aesthetics, ease of installation and of re-arrangement of the system, the communications and transfers of data between the various apparatuses constituting the system are made via a synchronous wireless network, that is to say sharing a common network clock. More particularly, this type of network is well-adapted to the transfer of data at constant rate, such as video or audio. As the type of video targeted is high definition, the wireless network can use the 60 GHz frequency band in order to ensure sufficient bandwidth.

In video transport systems, the images are generated by the sources according to a video clock. This clock defines the display cadence of the successive images and thus a frame rate, referred to as source frame rate. It conventionally corresponds to the value Vsync (“Vertical synchronization”) representing a signal of vertical synchronization of the images.

Where those images are transported via a network, synchronization means must be put in place at the location of the recipient apparatuses (or receivers) which themselves have their own local clock, in order to follow the source video clock. Without these synchronization means, the reception buffer memories of the recipient apparatuses would empty or fill up completely depending on whether the local frame rate is higher or lower than the source frame rate, so causing visual artefacts which for example take the form of an interruption of the video.

In the prior art, these synchronization means may be implemented by transporting the clock signal via a cable linking the different apparatuses. However, it is now sought to replace the cables by wireless networks. Furthermore, most of the apparatuses for the general public are not equipped to receive such a dedicated cable.

Other solutions consist in the use of PLLs (“Phase-Locked Loops”) as is presented in particular in the U.S. Pat. No. 7,499,044 (Silicon Graphics).

These PLL devices make it possible to precisely synchronize the clock of the recipient apparatus (slave clock) with that of the source clock (master clock). The speed of synchronization may be parameterized. If it is fast, the slave clock may undergo strong jitter, that is to say a temporal irregularity, which may have consequences on the processing of the transported data. To limit the jitter, the synchronization speed must be low, but, in that case, the time taken for re-synchronization in case of change in master clock (for example due to switching of the source) is long. Furthermore, the number of PLLs available in the hardware components is limited, and it is therefore necessary to use them judiciously.

In a multiple projection video system, the complete video display is in reality constituted by different image portions, the group of which constitutes a perfectly homogenous video image once synchronized. The synchronization between the different display devices (screens or video projectors) constitutes an essential technical requirement for the implementation of these systems. Such a system therefore does not withstand variations in different display speeds between two display devices.

Recourse is then sometimes made to the use of perfectly synchronized video sources. This “perfect” synchronization may be obtained by using an off-the-shelf multiple input synchronization apparatus (for example a device of “video wall controller” type, commercialized by the company Barco—registered trademark).

However, such an apparatus, reserved for high end professional use, has drawbacks with regard to its very high cost, and with regard to the technical and practical limitations of a resulting centralized system. This is because all the video sources must be connected to that central apparatus, which may prove incompatible with a utilization requiring certain video sources to be spaced more or less far away, preventing the use of cables, such as for example a set of several cameras performing extended capture for a single homogenous display in real time.

In the same vein, U.S. Pat. No. 5,517,253 (Philips) discloses a multi-screen multi-source synchronization device based on the use of recipient apparatuses having a common image clock. This solution is not satisfactory in the presence of recipient apparatuses not sharing an image clock.

Furthermore, the solution proposed in that prior art document implements an addition of pixels which proves to be poorly tolerated by certain recipient apparatuses.

Moreover, in a multi-source system of the type previously referred to, the switching between two sources poses the additional problem of the synchronization relative to a reference source. To be precise, each source follows its own image clock, and, when a destination changes image source, it must re-synchronize its image clock to follow that of the new source. The same applies when, for the same source, switching is made between two recipient apparatuses.

This change of reference clock requires progressive (and thus slow) processing operations at the synchronization means of the recipient apparatus which are used to follow the source clock. These processing operations prevent changeover that is both smooth and fast between the sources. To be precise, while the clock of the destination is not set to that of the source, the display is liable to be perturbed: a black screen is liable to appear until the destination clock has been re-synchronized.

These various drawbacks highlight the need to have more effective mechanisms available for synchronizing devices in a distribution system for distributing video streams of images, in particular to enable switching sources or recipient apparatuses without artefacts, and without implementing costly devices.

### SUMMARY OF THE INVENTION

The present invention aims to mitigate at least one of the aforesaid drawbacks by providing in particular a method of synchronization between devices of a distribution system for distributing video streams of images comprising, linked to a communication network, at least three sending or receiving devices, including a sending device and a receiving device,

a sending device being configured to receive, from a source, a source video stream having a frame rate, referred to as source frame rate,

a receiving device being configured to control the display, at a display cadence, referred to as display frame rate, of a video stream on a display device to which it is connected,

which method is characterized in that it comprises the steps of:
obtaining a frame rate, referred to as target frame rate, which is common for the devices,
adapting, by each device of the set of sending devices or of the set of receiving devices, a source video stream received from a source, respectively, directly or via a sending device, from the source frame rate to the target frame rate,
adjusting, at each receiving device, the display frame rate to the target frame rate so as to control a display at said target frame rate.

The method according to the present invention makes it possible in particular to switch between several sending devices linked to sources or to switch between several receiving devices provided for the display, without leading to artefacts resulting from the implementation of a re-synchronization of the devices as necessary in the prior art.

This capability is obtained by the use of a target frame rate common to the devices. Furthermore, this target frame rate proves to be stable over time, as will become apparent from what follows, having regard to its determination mechanisms.

Thus, on switching, the devices are already configured to adapt a source video stream to that common target frame rate and the receiving devices have processing speeds for the display which are already synchronized by adjustment of the display frame rates to the same target frame rate. The switching to another video source thus no longer requires any change in clock speed and thus re-synchronization of the devices.

In an embodiment, the step of obtaining the target frame rate comprises a step of determining a reference frame rate from among only the source frame rates.

For a receiving device switching between several sending devices, this provision makes it possible to have the same adaptation to perform, and thus also to dispense with a re-synchronization.

As a variant, the step of obtaining the target frame rate comprises a step of determining a reference frame rate from among the source frame rates and the display frame rates.

Thus, in addition to the preceding variant, homogeneity of the adaptations between receiving devices is obtained when a sending device switches between those various receiving devices.

In particular, the reference frame rate is the highest frame rate from among the source and display frame rates taken into account. By this provision, the reference is the fastest device in terms of frame rate. Thus, the other sending devices wishing to adapt their streams to that high frame rate will have to add data (by duplication of images, for example). Consequently, this implementation of the invention makes it possible to avoid the elimination of useful video data: the video data are thus entirely preserved.

According to a particular feature, said target frame rate is equal to the reference frame rate if the latter is a source frame rate, and is strictly greater than the reference frame rate if the latter is a display frame rate.

In this way, all sending devices are caused to apply the same type of adaptation (duplication of images) and all the receiving devices to apply the same type of adjustment/adaptation (removal of invisible lines for example since the target frame rate is greater than the receiving device's own frame rate.

It is to be noted that the use of a target frame rate strictly greater than the reference frame rate (for example by addition of a correction, typically 0.01 Hz (i.e. frames per second) for a final display of 25, 50 or 100 Hz type), enables some uncertainties in the adaptations and the latencies in the network to be mitigated.

In an embodiment of the invention, each device determines its own source or display frame rate and transmits, to the other devices, the determined frame rate together with an item of information on the type of device, sending or receiving, from which the transmitted frame rate comes.

This distributed work enables the costly use of a centralized apparatus to be dispensed with. Furthermore, this provision may be easily implemented with conventional sources, which is a notable advantage in terms of costs.

Lastly, it ensures that the computation of the target frame rate, which may depend on the type of device chosen as reference, is indeed conducted correctly by each device.

In particular, the determining of a device's own frame rate is made by determining a period of a synchronization signal of said device relative to a common network clock of the communication network.

This provision gives a common temporal reference of low complexity to implement the invention.

According to a particular feature, the step of obtaining the target frame rate is carried out on each device having received the values of synchronization signal period from the other devices of the network, by determining a reference frame rate on the basis of said received synchronization signal period values.

Once again, the determining of the reference frame rate is carried out in distributed manner, without requiring complex algorithms to elect a device to be in charge of that determining. In general terms, each device having all the necessary information may itself determine the reference frame rate and the target frame rate.

Furthermore, it may be provided that:
the determining, by the devices, of their own source or display frame rates,
the transmitting of those frame rates to the other devices, and
the obtaining, by each device having received the frame rates of the other devices, of the target frame rate by determining a reference frame rate on the basis of the source or display frame rates received,
   are carried out periodically by said devices.

This periodicity ensures tracking of the changes in the own clocks of each device (for example depending on temperature). Thus, the effectiveness of the invention may be maintained by periodically updating the reference or target frame rate using that monitoring. Complex mechanisms for managing drift and compensation may thus be avoided.

In an embodiment of the invention, the adapting of the source video stream comprises duplicating at least one image in order for the video stream to attain said target frame rate.

This provision, implementing image duplication, enables the integrity of the data to be maintained since there is no deletion of information. The visual comfort (on display of the video stream) is found to be improved.

Furthermore, the manipulation by entire image according to the invention proves to be of simpler implementation, at the network devices, than a manipulation by pixel or line.

In particular, the duplicating comprises a step of computing a drift between the source frame rate and the target frame rate, and the number of images to duplicate is a function of the computed drift to attain the target frame rate.

In an embodiment of the invention, the adapting of the source video stream is carried out by each receiving device receiving a source video stream that has a source frame rate less than the target frame rate.

This provision enables a saving in bandwidth on the network since the duplicated images are not sent over it.

In particular, it may be provided that said receiving device determines, on the basis of the target frame rate and the frame rate of said received source video stream, the images to duplicate in said video stream.

Thus, the sending device is not involved, which is advantageous when it is provided with limited hardware and software resources.

As a variant, said sending device determines the images to duplicate in said video stream and indicates them to a receiving device of said source video stream. In this configuration, the processing operations are equitably shared between the sending and receiving devices, while ensuring a reasonable use of the network bandwidth.

In particular, said images to duplicate are signaled in the header of packets carrying the video stream. This simplifies processing at the receiving device.

In an embodiment of the invention, the adapting of the source video stream is carried out by each sending device receiving a source video stream having a source frame rate less than the target frame rate.

It is thereby avoided to have recourse to additional memory resources on the receiving device side, that are provided to store the images to duplicate.

In particular, the adapting of the source video stream by a sending device is carried out by reading, at said target frame rate, a buffer memory storing said source video stream. As may have been stated earlier, this reading at the target frame rate is made possible by the presence of the duplicated images in the buffer memory.

In another embodiment of the invention, the adjusting of the display frame rate of a receiving device comprises a step of synchronizing by closed-loop control of the receiving device to compensate for a drift between the display frame rate and the target frame rate.

In this way, as the frame rates of each sending/receiving pair are closed-loop controlled, the reception buffer memories will never be completely empty nor too full.

In particular, the method may comprise:
detecting, by the receiving device, a positive drift representing a higher display frame rate than the target frame rate;
sending a warning signal to the other devices by the receiving device in response to the detection of a positive drift; and
updating the target frame rate by the devices in response to the warning signal.

This configuration makes it possible to rapidly change the target frame rate as soon as it is no longer the highest frame rate. Once again, by virtue of the dissemination of a warning signal and by virtue of the capacity of the devices themselves to determine the target frame rate, these operations may be totally distributed, without a bottle-neck node conventionally constituted by a central apparatus.

According to a particular feature, the updating of the target frame rate comprises:
determining, by the devices, of their own source or display frame rates,
transmitting those frame rates to the other devices, and
obtaining, by each device having received the frame rates of the other devices, of the target frame rate by determining a reference frame rate on the basis of the source or display frame rates received,
   According to another particular feature, the adapting of the source video stream comprises duplicating images at a duplication cadence in order for the video stream to attain said target frame rate, and the duplication cadence is updated upon detecting the warning signal

This provision makes it possible to have efficient adaptation, which follows the change in the target frame rate.

In an embodiment of the invention, the adjusting of the display frame rate of a receiving device receiving a video stream comprises deleting or adding at least one image line in an inactive part of an image of the video stream, so as to artificially modify the display frame rate on the receiving device.

In this way, it is not necessary to modify the pixel clock driving the display. The resulting display quality is found to be improved thereby.

In another embodiment of the invention, the method may comprise a step of re-adjusting a pixel clock (defining a reading cadence of the pixels in the video stream) of the receiving device when a negative drift representing a target frame rate, regenerated by the receiving device and lower than the target frame rate, is detected as being higher, in absolute value, than a threshold value.

In a complementary manner, the invention also relates to an image video stream distribution system comprising, linked to a communication network, at least three sending or receiving devices, including a sending device and a receiving device, taken from

a sending device configured to receive, from a source, a source video stream having a frame rate, referred to as source frame rate,

a receiving device configured to control the display, at a display cadence, referred to as display frame rate, of a video stream on a display device to which it is connected,

which system is characterized in that it comprises a means for obtaining a frame rate, referred to as target frame rate, which is common for the devices,

and wherein

each device of the set of sending devices or of the set of receiving devices, comprises means for adapting a source video stream received from a source, respectively, directly or via a sending device, from the source frame rate to the target frame rate,

and each receiving device comprises a means for adjusting its own display frame rate to the target frame rate so as to control a display at said target frame rate.

The system has similar advantages to those of the method set out above, in particular that of enabling switching of sources (via switching of sending devices for example) or of receiving devices provided for driving a display, without re-synchronization of the pair of devices communicating together.

Optionally, the system may comprise means relating to the features of the method set out above.

The invention also concerns a video stream sending or receiving device within a communication network comprising at least three sending or receiving devices, including a sending device and a receiving device, characterized in that it comprises:
means for receiving own frame rates from the other devices of the network;
a means for obtaining a common frame rate, referred to as target frame rate, by determining a reference frame rate on the basis of the received frame rates and on the basis of a frame rate local to said device defining a transmission frame rate for transmitting a video stream to a downstream device, in particular a display device.
means configured to adjust the local frame rate to the target frame rate so as to transmit, at said target frame rate and to the downstream device, a received video stream.

This device has similar advantages to those of the method set out above, and may optionally comprise means relating to the features of the method set out earlier.

In particular, the device may further comprise:
a means for determining a period of a synchronization signal of the device relative to a common network clock so as to obtain said frame rate local to the device,
means for transmitting, to the other devices of the network, the value of the determined synchronization signal period and an item of information on the type of device, sending or receiving, from which comes the transmitted value.

According to a particular feature, it may also comprise a buffer memory for storing data of said video stream, and be configured to write or read to or from said buffer memory at said target frame rate.

The invention also concerns an information storage means that is readable by a computer system, comprising instructions for a computer program adapted to implement a synchronization method in accordance with the invention when that program is loaded and executed by the computer system.

The invention also concerns a computer program readable by a microprocessor, comprising portions of software code adapted to implement a synchronization method in accordance with the invention, when it is loaded and executed by the microprocessor.

The information storage means and computer program have features and advantages that are analogous to the methods they implement.

### BRIEF DESCRIPTION OF THE DRAWINGS

The invention will be better understood with the help of the description, given below purely by way of explanation, of an embodiment of the invention, with reference to the accompanying drawings in which:

FIGS. 1a, 1b and 1c illustrate three examples of communication systems for implementations of the invention;

FIG. 2a represents a generic communication device capable of being used as a sending node 102 (DE) or as a receiving node 103 (DR);

FIG. 2b represents a communication device of sending node type having two sending parts 206 for receiving and processing two sources;

FIG. 3 illustrates details of interconnection between modules in the sending part 206 of FIG. 2a or 2b;

FIG. 4a illustrates a possible video packet format;

FIG. 4b represents the algorithm executed by the video packet transmission module 216 of FIG. 3 according to a first embodiment.

FIG. 4c represents the algorithm executed by the video packet transmission module 216 of FIG. 3 according to a second embodiment.

FIG. 5a is a detailed view of the “display part” module 205 of FIG. 2a;

FIG. 5b is a detailed view of the “Vsync regen” module 504 of FIG. 5a;

FIG. 5c represents the algorithm executed by the module 500 of FIG. 5a in the first embodiment;

FIG. 5d represents the algorithm executed by the module 500 of FIG. 5a in the second embodiment;

FIG. 6a illustrates the algorithm implemented by the drift management module 506 of FIG. 5a;

FIG. 6b represents the algorithm executed by the “Vsync monitor” 530 of FIG. 5b;

FIG. 7 illustrates an algorithm for computing the source or display frame period by the communication device of FIG. 2a or 2b, according to the invention;

FIGS. 8a, 8b and 8c illustrate, in algorithm form, the operation of the “video synchro generator” module 503 of FIG. 5a;

FIGS. 9 and 10 illustrate an algorithm for determining video stream correction parameters, comprising the determination of the target frame period and of a corresponding duplication period as well as their monitoring for updating, according to the invention; and

FIGS. 11a and 11b illustrate the operation, according to the invention, of the writing and reading operations of the buffer memory 312 of FIG. 3.

### DETAILED DESCRIPTION OF EMBODIMENTS OF THE INVENTION

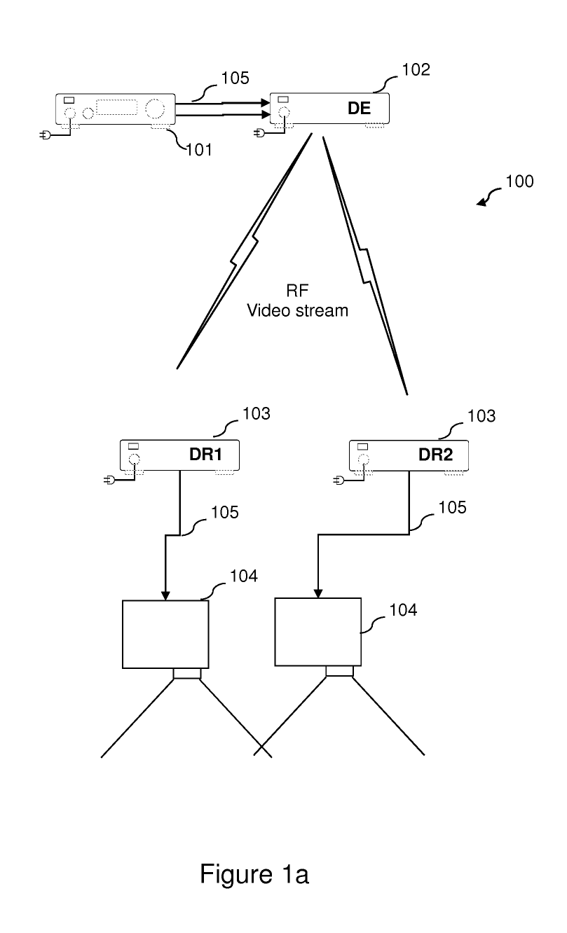

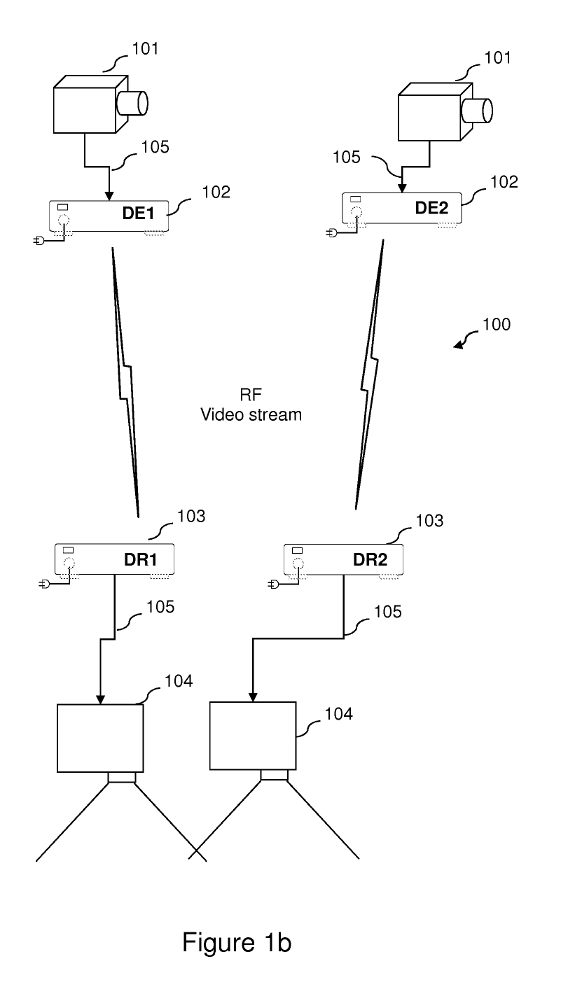

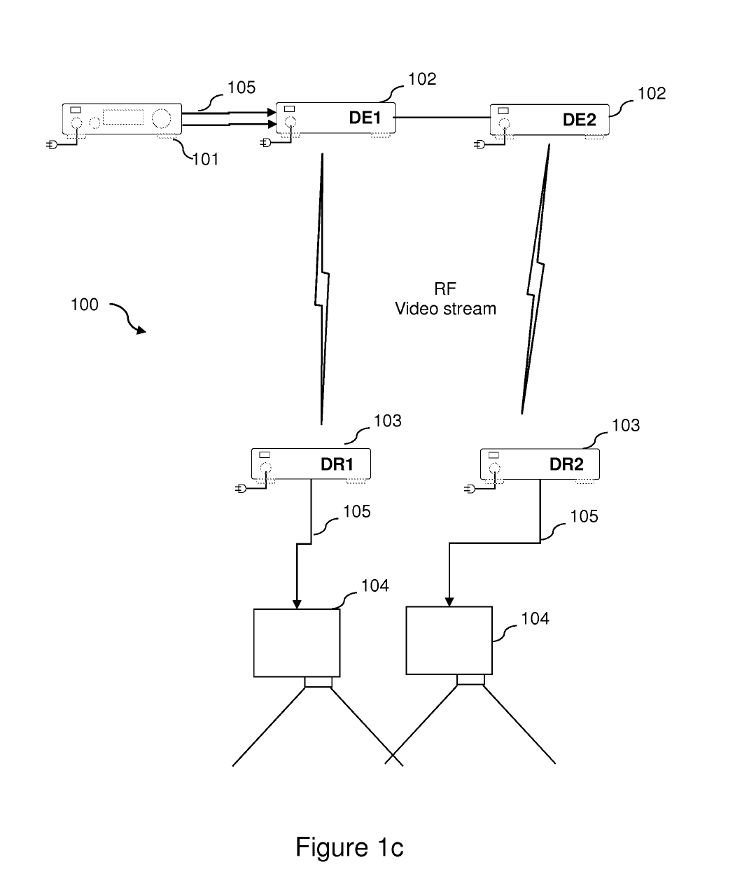

FIGS. 1a to 1c present various non-illustrative contexts in which the invention may be applied, in particular for the purposes of supplying a common cadence, or target frame rate denoted FlmTarget below, to all the devices of a distribution system for distributing video stream. The use of such a common cadence makes it possible to avoid re-synchronization of the devices in case of switching, for a receiving device, between sending devices or nodes linked to sources or, for a sending device, between receiving devices or nodes provided for the display of the video stream.

FIG. 1a presents a first scenario of use of a wireless multi-projection system 100. The system 100 comprises in particular a centralized video source 101 able to supply several video outputs simultaneously (PC video server for example of which the two source outputs are not synchronized). The video source 101 is connected to a sending device (DE) or sending node 102 (the network nodes connected to one or more sources will be designated “sending nodes” below) through a standard digital video connection (for example in accordance with the HDMI standard). The sending device 102 communicates with receiving devices (DR) or receiving nodes 103 by means of wireless transmission (for example 60 GHz 801.15.3c). Each receiving node 103 is connected to a display device 104 such as a screen or projector by means of a standard digital video connection 105 (for example in accordance with the HDMI standard). The network nodes connected to one or more display devices will be designated “receiving nodes” below.

The sending node 102 receives video streams or video data DATA referred to as “source” from the source 101. These streams have their own frame rate, referred to as source frame rate (in frames per second for example) denoted FlmSource.

The sending node 102 sends these video streams by means of a wireless network to the receiving nodes 103. These latter then deliver the received source video streams to the projectors 104 while imposing a throughput for the corresponding display with a display frame rate (FlmAff, number of frames per second) that is controlled by each of the receiving devices (display frame rate defined by the clock local to the receiving device).

The source video streams are two portions of the same image. Thus, they are projected in real time in the form of a single homogenous large image by the multi-projection system 100.

In this scenario, the sending node 102 considers each source output as independent, and, for each of the source outputs (thus each source video stream), executes operations for computing source, reference or target frame rate and duplication period as described below.

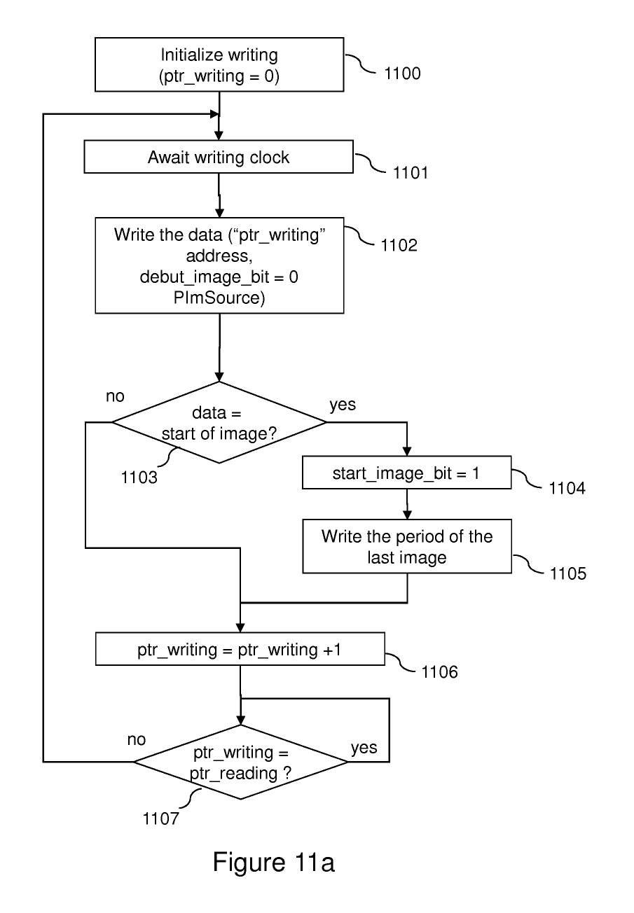

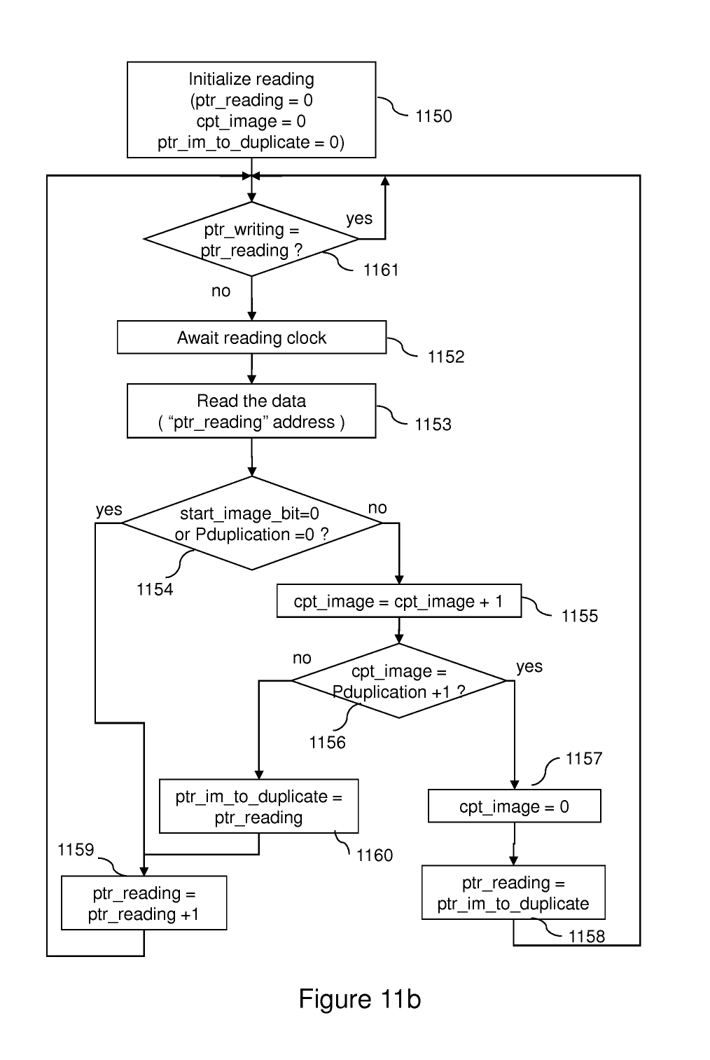

It is to be noted that in an embodiment in which the sending device or node DE performs an adaptation of the source video streams in order for them to be in accordance with the target frame rate before transmitting them to the receiving devices or nodes DR, a buffer memory 312 as described below with reference to FIGS. 11a and 11b, is provided at that sending node 102 for each of the source outputs.

In what follows, a period will be denoted “P” and a corresponding frame rate will be denoted “F”: F=1/P. These values will be used in the same way to designate a characteristic of a synchronization signal.

Thus, PlmSource and FlmSource represent the source frame period and source frame rate of a video stream DATA from a source 101;

PlmAff and FlmAff represent the display frame period and display frame rate controlled by a receiving node to drive the display of a video stream on a display device;

PlmLocal and FlmLocal represent the frame period and frame rate specific to a sending or receiving device. It is to be noted that PlmLocal and FlmLocal respectively designate PlmSource and PlmAff, and FlmSource and FlmAff;

PlmRef and FlmRef designate reference frame period and reference frame rate;

PlmTarget and FlmTarget designate target period and frame rate.

In a second scenario illustrated by FIG. 1b, two video projectors 104 display two video streams generated by two corresponding high definition cameras 101.

The output of each camera 101 is linked to a sending node 102 (for example via an HDMI cable) which sends a video stream to a corresponding receiving node 103 via a wireless network. The receiving nodes deliver the received video streams to the respective projectors 104.

The video streams are then projected in real time in the form of a single homogenous large image by the multi-projection system 100.

In this scenario, each sending node 102 executes operations for computing source, reference or target frame rate and duplication period as described below, for the source 101 to which it is attached.

It is to be noted that in an embodiment in which the sending devices or nodes DE perform an adaptation of the received source video streams in order for them to be in accordance with the target frame rate before transmitting them to a receiving device or node DR, a buffer memory 312 as described below with reference to FIGS. 11a and 11b, is provided at each sending node 102.

FIG. 1c presents a third scenario of use of a wireless multi-projection system 100.

In this scenario, two video projectors 104 display the data coming from a centralized video source 101 generating several video outputs simultaneously (PC video server for example). These video outputs are supplied to a first sending device or node DE1 which encodes a first video stream DATA and sends it via the wireless network to a first node or receiving device DR1.

The first sending device or node DE1 is connected to a second sending network device or node DE2, for example by means of an Ethernet type link or a high throughput bus of IEEE 1394 type.

The first sending device or node DE1 transmits the data corresponding to a second video stream to the second sending device or node DE2 via that link. This second sending node next transmits the second video stream via the wireless network to a second receiving device or node DR2.

The receiving nodes 103 deliver the received video streams to the projectors 104 which project them in real time in the form of a single large homogeneous image.

This scenario enables network path diversity to be introduced for an increased resistance to the perturbations of a path, and/or enables the bandwidth of the network to be increased if the two sending/receiving pairs use different radio frequencies.

In this scenario, the first sending device or node DE1 considers each source output as independent, and executes operations for computing source, reference or target frame rate and duplication period as described below, for each of the source outputs.

It is to be noted that in an embodiment in which the first sending device or node DE1 performs an adaptation of the source video streams in order for them to be in accordance with the target frame rate before transmitting them to the receiving devices or nodes DR, a buffer memory 312 as described below with reference to FIGS. 11a and 11b, may be provided at that first sending device or node DE2 for each of the source outputs.

As a variant, each sending node 102 may execute these processing operations uniquely for the source output which it forwards to a receiving node 103. A buffer memory 312 in each sending node can then be provided to process the video stream it deals with.

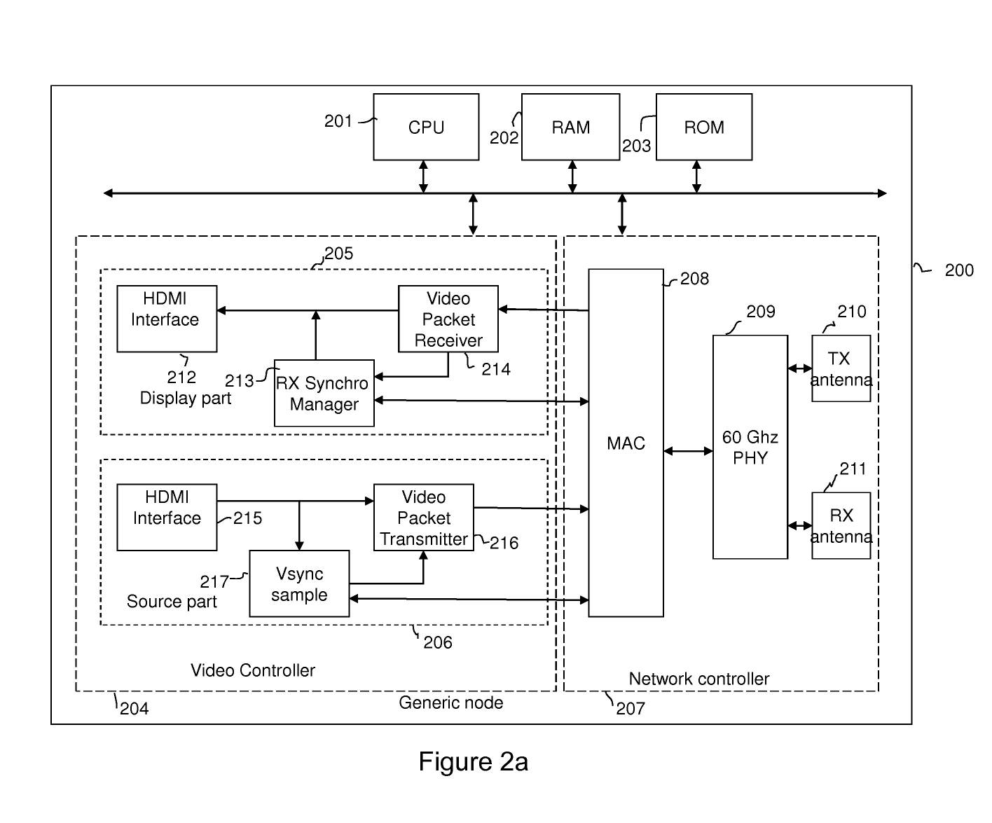

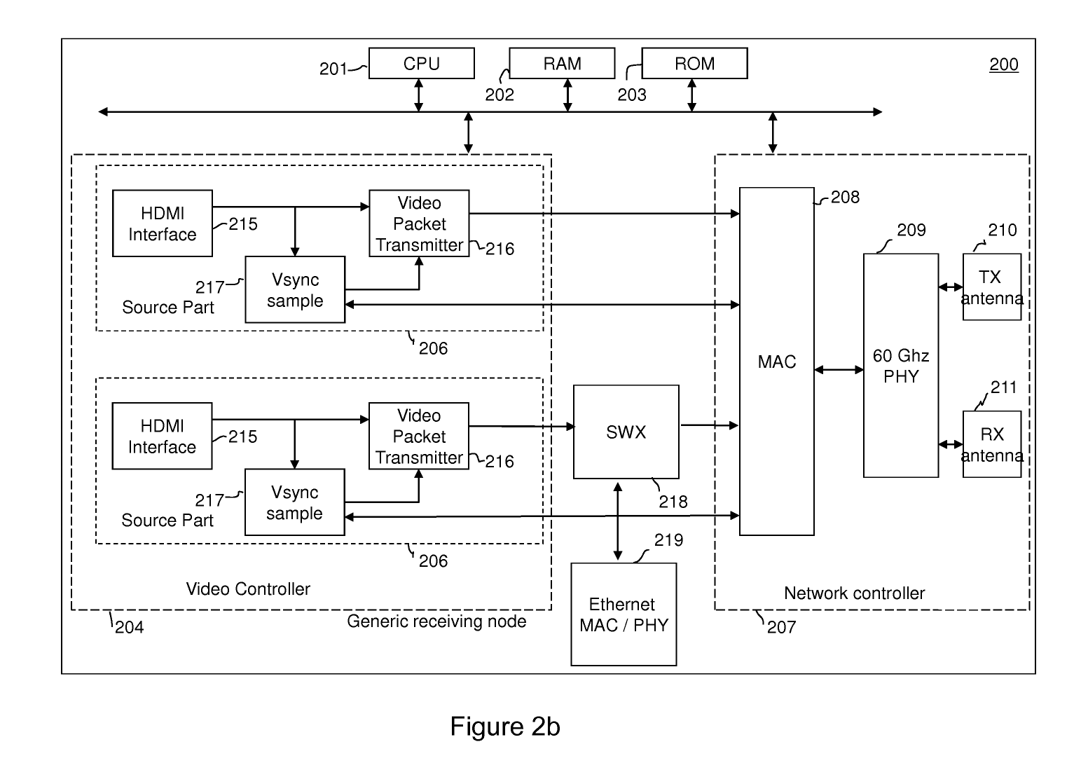

FIG. 2a represents a communication device or generic node capable of being used as sending node 102 or as receiving node 103.

The generic node is constituted by a video controller part 204 and by a network controller part 207. The network controller part 207 is in charge of implementing the wireless communications of the video data and of the control data. The controller part 204 comprises a display sub-part 205 and a source sub-part 206. The display sub-part 205 is in charge of playing the video received (in the form of a video stream) from the network controller 207 on a video display device such as the display device 104. The source sub-part 206, for its part, has the task of capturing a video stream coming from a video source device such as the source 101 and of sending it to the receiving node such as the node 103 through the network controller part 207. The two parts 204 and 207 are controlled by a CPU system composed of a data processing unit (CPU) 201, of a random access memory (RAM) 202 and of a read only memory (ROM) 203.

The network controller part 207 is a communication sub-system in accordance with the 60 GHz standard, implementing either the IEEE 802.15.3 standard or the WirelessHD standard. It is composed of a MAC module 208, of a PHY module 209, of a transmission antenna module 210, and of a reception antenna module 211. For the detailed description of these modules, the reader may refer either to the IEEE standard (standard 802.15.3 modification c) or to the documentation of the WirelessHD consortium. The network controller 207 also makes a network protocol operate which ensures that all the nodes of the network have access to a single temporal reference: a network clock. For example, the network controller may implement the IEEE 1588 protocol.

The source sub-part 206 of the video controller part 204 comprises an HDMI receiving module 215 capable of receiving a video stream in HDMI format from a video source 101, through an HDMI connector 105. This HDMI receiving module 215 outputs image or pixel data on a bus, as well as several video control or synchronization signals.

For example, three video synchronization signals, that is to say a pixel clock signal, a horizontal synchronization signal and a vertical synchronization signal, are transmitted to two modules 216, 217.

It should be noted that the HDMI receiving module 215 may for example be a module commercialized under the reference AD9880 by the company Analog Device.

The module 216 is a video packet transmission module which receives video data from the receiving module 215.

From the module 217, called “Vsync Sampler” module, the module 216 also receives temporal information, in particular a vertical synchronization period (Vsync) for the video data. This period is defined between two successive rising edges of the vertical synchronization signal supplied by the HDMI interface. For the corresponding sending device 102, it represents a frame rate, also designated “source frame rate” FlmSource.

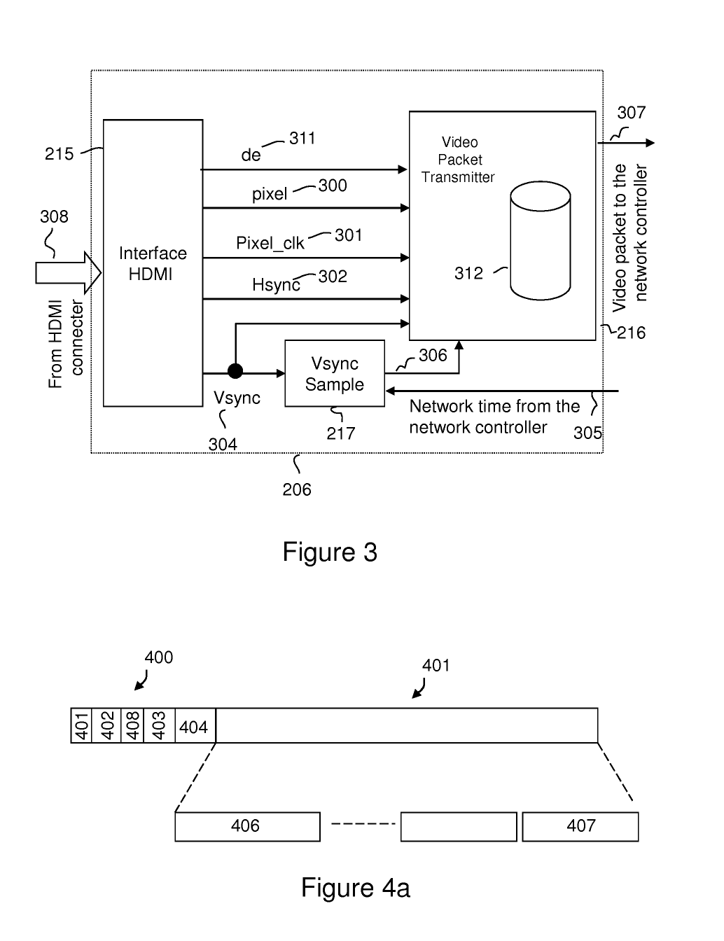

The module 216 constructs video data packets as will be described in more detail with reference to FIG. 3 and transmits them to the network controller part 207.

The module 217, for its part, has the task of the sampling of the appearances of the vertical synchronization signal Vsync coming from the HDMI receiving module 215, and outputs, to module 216, the last period value PlmSource of the sampled data.

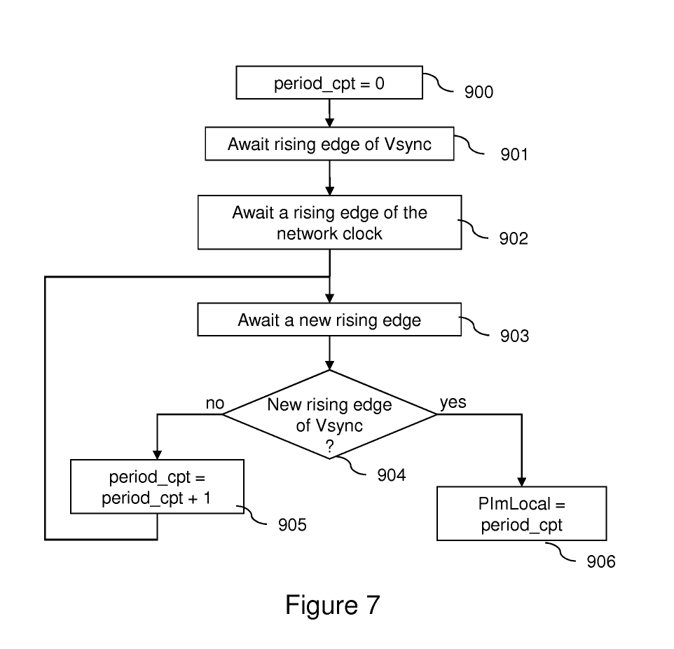

The sampling is more particularly carried out by generating a time stamp relative to a network time serving as reference, as it is received by the network controller part 207. The period PlmSource between two consecutive rising edges may thus easily be calculated by subtracting the two times corresponding to those rising edges. The calculation of the period PlmSource is described below with reference to FIG. 7 by, for example, the implementation of a counter incremented at each network clock rising edge between two rising edges of the source synchronization signal.

The value of the period PlmSource may then be transmitted to the module 216 in order for the latter to exploit it.

The display sub-part 205 comprises a video packet reception module 214 which receives packets from the network controller part 207.

From the received packets the module 214 extracts the image data or pixels contained in those packets in order to store them and extracts any period value PlmTarget (if that information is provided as explained later) which is then transmitted to an RX synchronization management module 213.

The module 213 generates video control or synchronization signals on the basis of that period PlmTarget, and transmits them to an HDMI transmitting module 212.

The module 213 also reads the pixels stored in the module 214 following that synchronization and transmits them to the HDMI transmission module 212.

As will be seen subsequently, a receiving node has at its disposal all the information useful for determining the target frame rate or period. Thus, the indication of the target period in the transmitted packets can be dispensed with.

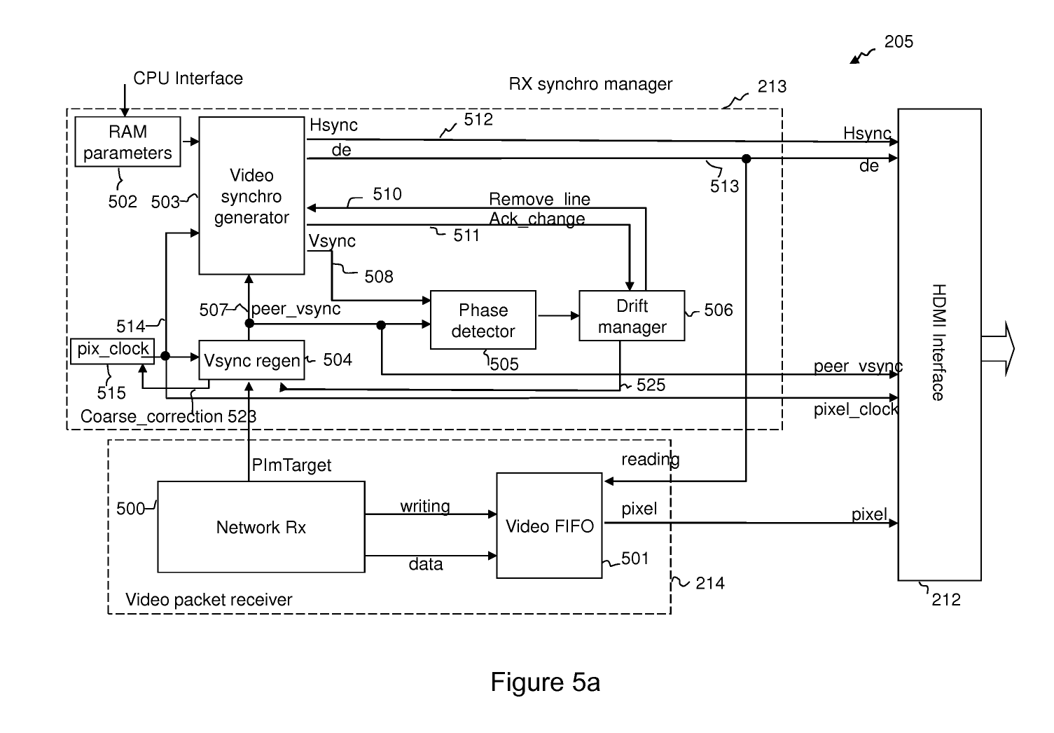

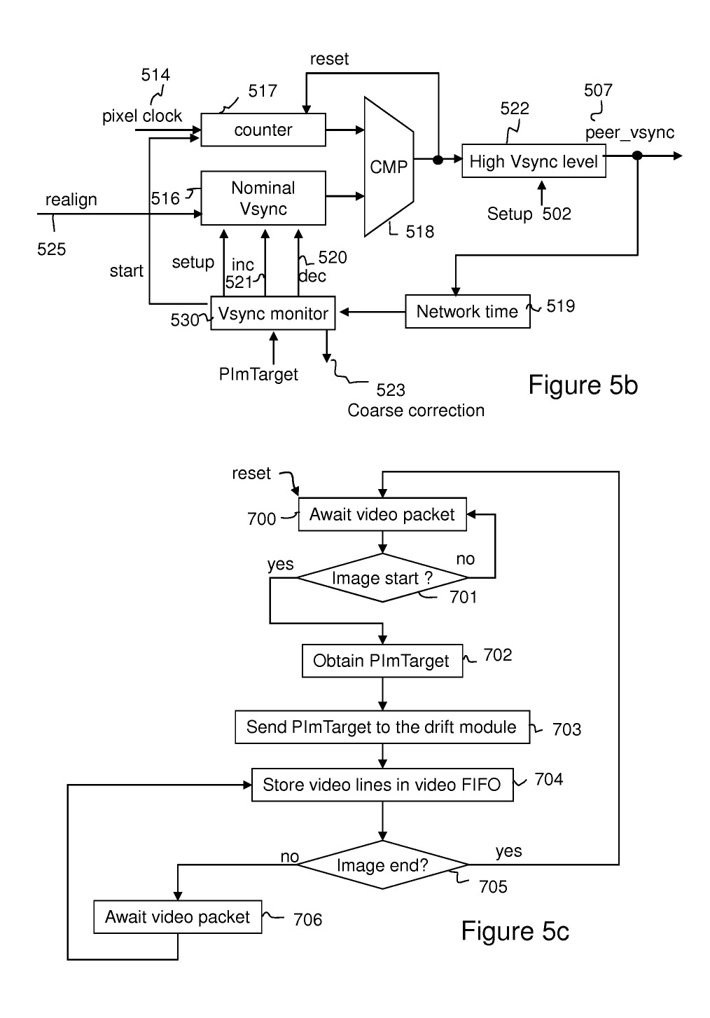

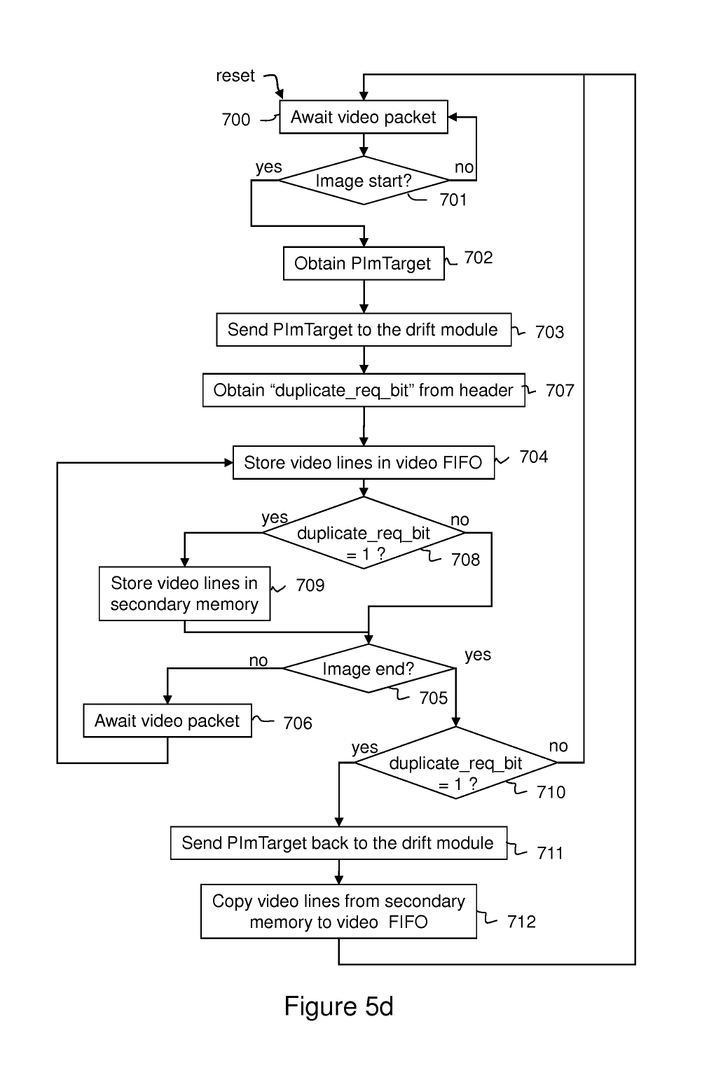

The display sub-part 205 will be described in more detail with reference to FIGS. 5a and 5b.

The HDMI transmission module 212 employs an HDMI TX controller for the purpose of the control and the display of the data on the display device 104.

More particularly the HDMI transmission module 212 receives as input the pixels conveyed by a bus as well as the three video control or synchronization signals, that is to say respectively a pixel clock signal, a horizontal synchronization signal and a vertical synchronization signal. Through the implementation of the invention, these signals are consistent with a display of the video data at the target frame rate.

The module 212 drives an HDMI connector as output.

It should be noted that the HDMI transmitting module is for example commercialized by the company Analog Device under the circuit reference AD9889B.

The receiving 215 and transmitting 212 modules are controlled and initialized by the CPU unit 201 via a bus 12C not shown in the interest of clarity.

Furthermore, the CPU unit employs an HDMI software driver which may be obtained from a manufacturer of chips or circuits in accordance with the HDMI standard.

It will be noted that a sending node or device DE has the video controller part 204 which includes a source sub-part 206.

However, for the sending node or device function, the display sub-part 205 is not necessary.

Similarly, a receiving node or device DR has a video controller part 204 including the display sub-part 205 without however necessarily including the source sub-part 206 which is not necessary for this functionality of the node.

FIG. 2b illustrates a sending device DE which may simultaneously process several source video streams, such as in the scenarios of FIGS. 1a and 1c. In the present example, the device is “double” in that it comprises two source sub-parts 206, and may thus process the data coming from two sources simultaneously. Of course, a higher number of sub-parts 206 and of sources may be envisaged for the same device.

The video data coming from a first source are transmitted to the network module 207, via a first source sub-part 206 (that at the top in the drawing) as previously explained.

The video data DATA of the second source are processed by the second sub-part 206, then pass by a routing module 218. This module 218 makes it possible to direct the video data either to the wireless network module 207 (scenario of FIG. 1a for example), or to a wired network module 219 to transmit the video data to a second sending node DE2, in order to duplicate the paths of the wireless network data (increased robustness with regard to perturbations) or to increase the total bandwidth of the wireless network (scenario of FIG. 1c for example).

The wired network module 219 may be of broadband Ethernet or IEEE 1394 type for example.

Of course, the invention may employ other types of hierarchy for these modules, for example using a routing module 218 taking into account all the video streams output from the sub-parts 206.

As indicated above, FIG. 3 gives a more detailed illustration of the interconnections between the different modules of the source sub-part 206 of FIG. 2.

The HDMI reception module 215 receives an HDMI video data stream 308 from an HDMI connector not shown in FIG. 3, and outputs the different types of received data.

More particularly, the module 215 supplies a bus 300 with image or pixel data as well as a “de” control signal 311 called “Data Enable” and video synchronization control signals 301 (pixel clock signal Pixel_clk), 302 (horizontal synchronization signal Hsync) and 304 (vertical synchronization signal Vsync).

The sampler module of the Vsync signal 217 receives the signal 304 called “Vsync” from the HDMI receiving module 215 and receives from the network controller part 207 a network time reference 305 generated by a common network clock of the communication network to which the different sending and receiving devices are connected.

In turn, the module 217 generates and sends to the module 216 an item of duration information 306 representing the period PlmSource.

The video packet transmission module 216 receives the various aforementioned data 300, 311, 301, 302 and 304 from the HDMI receiving module 215 and, from the module 217, the item of information on duration 306 representing the period PlmSource.

Module 216 then builds the video data packets 307 on the basis of the preceding data and information and transmits them to the network controller part 207.

It is to be noted that if the sending nodes indicate, in the packet header, the target frame period/rate after adaptation of the video data in accordance with the invention, the module 216 also receives information relative to the frame rates FlmLocal specific to the other devices. It is on the basis of these specific frame rates that the sending node can determine the target frame rate and proceed with the adaptation of the video data DATA by duplication of images, as explained later.

In an embodiment in which the sending devices or nodes DE perform this adaptation of the received source video stream in order for it to comply with the target frame rate before transmitting them to a receiving device or node DR, the module 216 also comprises a buffer memory 312 (a sending device may thus contain several buffer memories 312 if it has several source sub-parts 206).

The buffer memory 312 is dimensioned so as to contain at least two whole images for example. According to the cases of use, this value may be adjusted. Its management is described below with reference to FIGS. 11a and 11b.

It is used to duplicate certain images on the wireless network part while continuing to receive the data from the module 215. This duplication ensures the adaptation of the source video stream received in order for it to reach the target frame rate, that is to say a target rate. For example, by duplicating one image every 100 images, it is possible to pass from a source frame rate of 25 im/s to a target frame rate of 25.25 im/s.

It is to be noted that the wireless network is provided to have a useful bandwidth equal to or greater than that of the fastest source 101 (having the greatest throughput) in the system 100, so as not to constitute a bottleneck on the data path.

To be precise, in the present embodiment, the implementation of the invention provides, as described below, for the buffer memory 312 to be read at the rate corresponding to the target frame rate on all the sending devices or nodes DE, so that the transmission of the images so duplicated is distributed over the whole of the image duplication period without creating a transmission peak on the network.

By efficiently choosing the target frame rate FlmTarget, for example the highest frame rate from the set of source frame rates (FlmSource) as described later, the buffer memory 312 is thus read faster than it is written to: writing with the rate corresponding to the local source frame rate, and reading with the rate corresponding to the target frame rate, that is to say the highest source frame rate.

This speed difference is however compensated for, according to an embodiment of the invention, by the duplication of the reading of the data corresponding to the images to duplicate as is described in more detail below with reference to FIG. 11b.

A description is now made with reference to FIG. 7, of the determination of the value of the “PlmLocal” period of the vertical synchronization signal Vsync by the sampler modules 213 and 217 of the sending and receiving nodes. PlmLocal means PlmSource or PlmAff according to the type of device (sending or receiving) taken into account.

This algorithm comprises a series of steps, instructions or portions of software code executed on executing the algorithm.

These modules receive the network clock from the module 208, and the signal Vsync 304/508 from the module 215 for the sending nodes or from the module 214 for the receiving nodes.

During a first step 900, a “period_cpt” counter is initialized to 0, then a rising edge of the signal Vsync is awaited (step 901).

The arrival of a rising edge Vsync triggers the awaiting of a rising edge of the network clock (step 902).

Waiting for a new rising edge is then commenced (step 903). If the following rising edge is not a rising edge of the signal Vsync (test 904—in which case it is a rising edge of the network clock), the “period_cpt” counter is incremented (step 905).

Waiting for the following rising edge is resumed by returning to step 903.

If a new rising edge on the signal Vsync has been observed, the value of the “period_cpt” counter is provided as a result (step 906).

Thus, the result provided represents the number of network clock rising edges during which there is one more rising edge on the signal Vsync. Relative to the network clock, this result thus represents the “PlmLocal” synchronization period specific to the device considered, that is to say the “FlmLocal” frame rate specific to that device, i.e. the source frame rate FlmSource for a sending device and the display frame rate FlmAff for a receiving device.

To obtain a more precise result, the computation may be made over several consecutive periods of the signal Vsync. The precision of the measurement also depends on the ratio between the periods of the signal Vsync and of the network clock. If the network clock period is too long relative to that of the signal Vsync, a multiple of the network clock may be used.

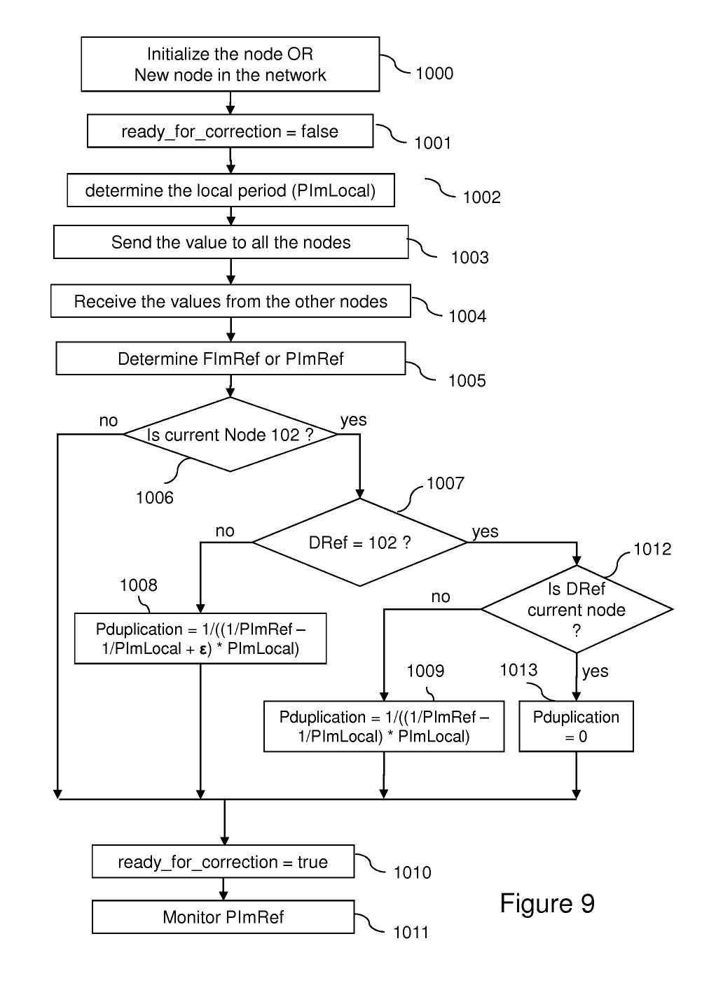

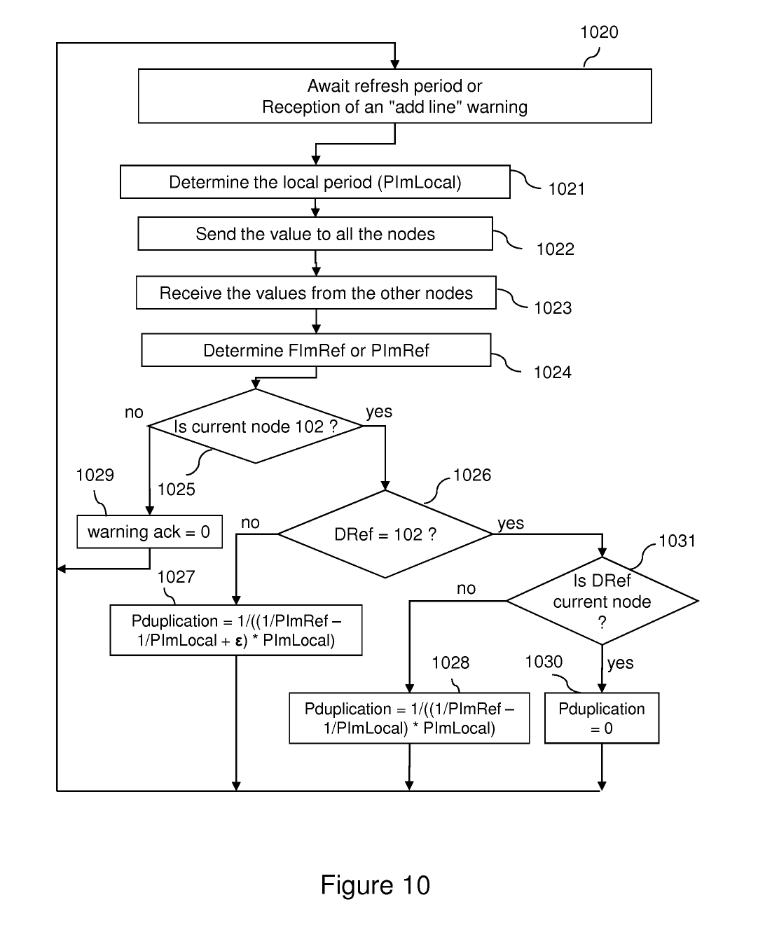

With reference to FIGS. 9 and 10, a description is now given of the mechanisms implemented in an embodiment of the invention to obtain and keep up to date the target frame rate FlmTarget common to all the devices, as well as the image duplication period (denoted Pduplication) that each device indicates or implements to adapt a video stream to the target frame rate.

The algorithms describing these mechanisms each comprise a series of steps, instructions or portions of software code executed on executing the algorithm.

As will be apparent below, an embodiment of the invention provides that the obtaining implements determining, by each node of the network (sending or receiving), a value representing the “local” frame rate FlmLocal which it employs: for a sending node 102, a source frame rate corresponding to the frame rate of the video data received from the source 101; for a receiving node 103, a display frame rate corresponding to the frame rate of the video data that it transmits to the display device 104, as described earlier in relation to FIG. 7. This frame rate may in particular be indicated in the form of the period PlmLocal of the vertical synchronization signal Vsync, relative to a common network clock.

Each “locale” frame rate FlmLocal (source or display) or corresponding period PlmLocal is then transmitted, by each of the nodes to all the other nodes of the network, accompanied by a “Type” item of information giving the device type, sending or receiving, from which comes the transmitted frame rate.

Each node of the network, or possibly a sub-part of those nodes (for example in the embodiment in which all the adaptations are made uniquely on the receiving nodes without participation by the sending nodes after having sent those local frame rates FlmLocal) then determines a reference frame rate “FlmRef” from among the local frame rates received, in particular by selecting the highest frame rate (i.e. the shortest period PlmLocal) from among the local frame rates FlmLocal taken into account. This reference frame rate thus corresponds to a device of the network, denoted below reference device or node DRef.

According to a first embodiment, only the local frame rates FlmLocal of source frame rate FlmSource type (coming from the sending nodes) are taken into account. As a variant, it is possible to take into account the source FlmSource and display FlmAff frame rates. Other approaches are also possible under the invention.

The target frame rate FlmTarget may then be deduced from the reference frame rate FlmRef, and depend on the type corresponding to the reference device (deduced from the “Type” item of information attached to the local frame period held as reference period). For example, the target frame rate FlmTarget is equal to the reference image frame rate FlmRef if the latter is a source frame rate (“Type”=sending): FlmTarget=FlmRef, and the target frame rate FlmTarget is strictly greater than the reference frame rate FlmRef if the latter is a display frame rate (“Type”=receiving): FlmTarget=FlmRef+ε, where ε is very low compared with FlmRef, in particular less than 0.1%, for example ε=0.01 Hz=0.01 im/s.

As will be seen below, the adaptation of the video data DATA according to the invention may then include duplicating images in those video data in order for those data to attain a frame rate equal to FlmTarget once the duplication has been carried out.

According to various embodiments, this adaptation may be conducted by each receiving node or by each sending node receiving source video data which have a source frame rate lower than the target frame rate. As each node receives the frame rates FlmLocal from all the other nodes of the network, it is capable of determining the target frame rate FlmTarget and thus of deciding whether it must perform such an adaptation.

In the case in which the receiving nodes perform this adaptation, the images to duplicate may be determined by themselves, or, as a variant, by the sending nodes which then indicate them in the video data, for example in the video data packet headers.

This adaptation of the video data to the target frame rate FlmTarget enables the communications between different devices of the network to take place using that common frame rate. Thus, any switching between the devices of the network does not give rise to synchronization.

Lastly, to enable a coherent display of these video data (without display cut-off or offset between several portions of the same image displayed on several juxtaposed display devices), the display frame rates FlmAff of the receiving nodes are also adjusted to the target frame rate FlmTarget. More particularly this results in an optimal management of the reception buffer memories of the receiving device, since the reading and writing from and to these memories is carried out at the same target frame rate FlmTarget which avoids excessive emptying or filling of those memories (liable respectively to induce image cut-of and image loss).

Thus, where the sending nodes themselves perform the adaptation of the video data DATA (or at the very least perform the determination of the images to duplicate to carry out that adaptation), with reference to FIG. 9, step 1000 marks the beginning of the algorithm in any sending node 102 or receiving node 103 of the network. This step may correspond either to the end of the initialization of the node where the latter has just joined the existing network, or to the detection of another node that has just joined the network.

The designation “ready_for_correction” is given to a variable indicating that the computations for common frame rate parameters and for duplication period (“correction parameters”) have been carried out for the current node. This variable takes the value “false” during step 1001. It is to be noted that it will keep this value while the above parameters have not been determined for that node.

At step 1002, the value of the period PlmLocal is determined in accordance with what has been described above with reference to FIG. 7.

This value is then sent, at step 1003, to all the other nodes of the network, by means of a message containing in particular the measured value and the type of the current node (sending or receiving).

Once all the values computed by the other nodes of the network have been received by the current node (step 1004), the reference frame rate FlmRef is determined by the latter (step 1005) as being the frame rate FlmLocal having the shortest period PlmLocal.

As all the nodes of the network have the same information at their disposal, they will converge in the determination of the reference frame rate FlmRef.

If the current node is a receiving node 103 (linked to a projector—test 1006), it is ready to apply corrections to the frame rate of the received video data (by duplication in order to adapt the overall throughput) and thus proceeds to step 1010 setting the “ready_for_correction” variable to “true”. However, if it must itself determine the duplication periods, it implements the processing operations described below for a sending node.

Otherwise (current node=sending node 102), the duplication period Pduplication for the images (in number of images) to attain the target frame rate FlmTarget is computed.

Where the reference frame rate FlmRef corresponds to a source frame rate FlmSource (test 1007) and the current node is not the reference node DRef (test 1012—node whose signal Vsync is the reference signal), the duplication period Pduplication is equal to (step 1009):

1/((1/PlmRef−1/PlmLocal)*PlmLocal)

where PlmRef is the period of the reference frame rate FlmRef, and PlmLocal is the period corresponding to the local frame rate FlmLocal of the current node.

Thus, by duplicating one image every “Pduplication” images, the current source node obtains a frame rate equal to the target frame rate FlmTarget, itself equal to the reference frame rate FlmRef.

It is to be noted that if the current node is a sending node 102, and is the reference node DRef (tests 1007 and 1012), it has no correction to make since the throughput of the video data DATA is already appropriate. In this case, Pduplication=0 for it to be differentiated from the other nodes (step 1013).

Where the reference frame rate FlmRef corresponds to a display frame rate FlmAff (test 1007), the duplication period Pduplication is equal to (step 1008):

1/((1/PlmRef−1/PlmLocal+E)*PlmLocal)

where ε (identical for all the nodes) has for example the value 0.01 Hz.

Thus, by duplicating one image every “Pduplication” images, the current source node obtains a frame rate equal to the target frame rate FlmTarget=FlmRef+ε.

The current node is thus ready to apply the corrections and thus proceeds to step 1010, during which the “ready_for_correction” variable takes the value “true”. Next a phase of monitoring and updating of those parameters (Pduplication and FlmTarget), is proceeded to, represented in the Figure by step 1011.

This is because as the clocks of the sources 101 (defining the source frame rates) and of the various nodes (display frame rates for the nodes 103) may vary over time (with ambient temperature for example), it may occur that the signal Vsync chosen as reference at the time of the initialization is no longer the fastest when time has elapsed.

Step 1011 thus aims to regularly or periodically verify and if necessary update the choice of the reference signal Vsync and thus the value of the target frame rate FlmTarget, as well as corrections to make (Pduplication in particular).

This step 1011 is now described in more detail with reference to FIG. 10.

It is to be noted that, as in steps 1000 to 1010, this monitoring and updating comprises:
determining, by the nodes, of their own source or display frame rates FlmLocal,
transmitting those frame rates to the other devices, and
obtaining, by each node having received the frame rates of the other nodes, the target frame rate FlmTarget by determining a reference frame rate FlmRef on the basis of the source or display frame rates received,

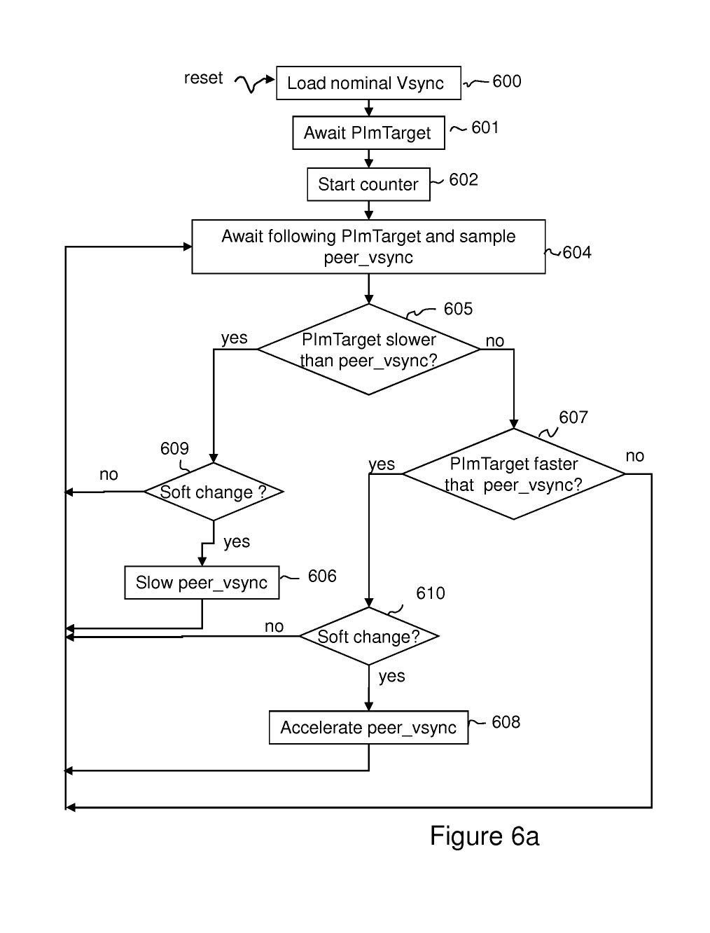

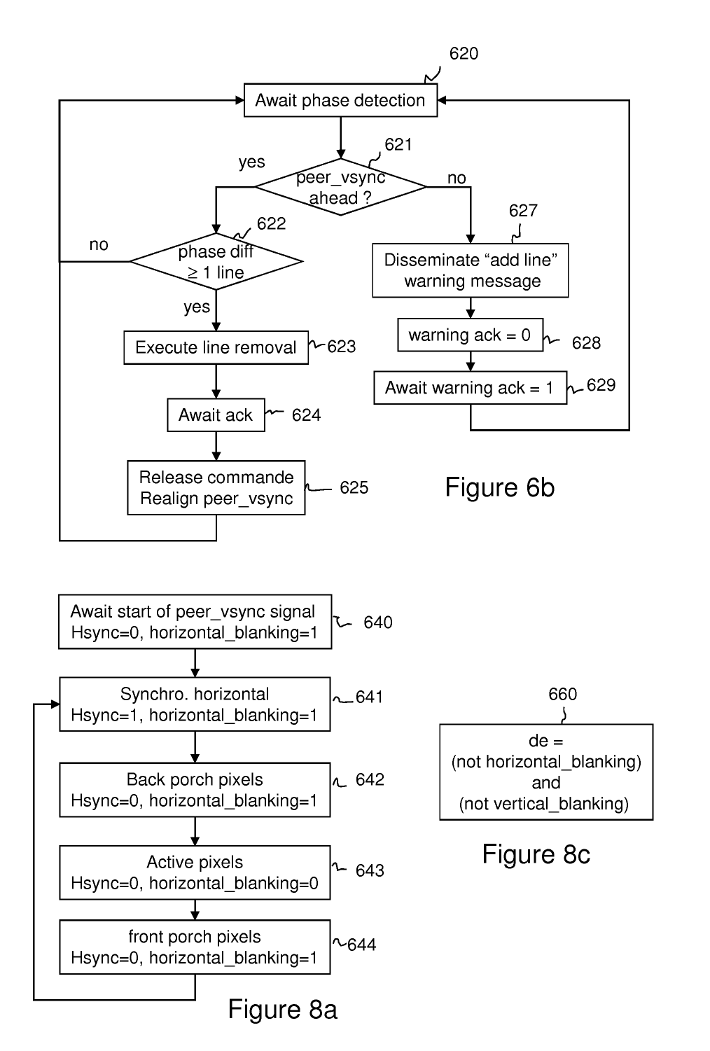

During step 1020, either the end of a refresh period for the correction parameters is awaited (for example every minute), or the arrival is awaited of a warning message “add line” from a receiving node (described below with reference to FIG. 6b).

This message arrives either by the wireless network or internally if the line adding detection is made on the current node. This warning is triggered by a receiving node 103 for which the clock correction algorithms (described later) detect that the synchronization signal Vsync that they generate has become faster than the target frame rate FlmTarget. More particularly, this means that lines should be artificially added in certain images to maintain the synchronization for the display, which is not provided for in this embodiment of the invention.

Further to step 1020, step 1021 is proceeded to similar to step 1002 to obtain the period PlmLocal of the current node. Steps 1022 to 1025 are similar to steps 1003 to 1006 enabling the sending of the PlmLocal's to the nodes and the determining of the frame rate FlmRef by the nodes.

If the current node is a receiving node 103 (linked to a projector), a variable denoted “warning_ack” takes the value 0 at step 1029.

This variable is used by the receiving node which may have detected and signaled an “add line” warning to confirm that the warning has been taken into account (see FIG. 6b).

Next, step 1020 is looped back to.

If the current node is a sending node 102, the duplication period Pduplication of the images (in number of images) is updated at steps 1026 to 1030, in similar manner to steps 1007 to 1013.

Next, step 1020 is looped back to.

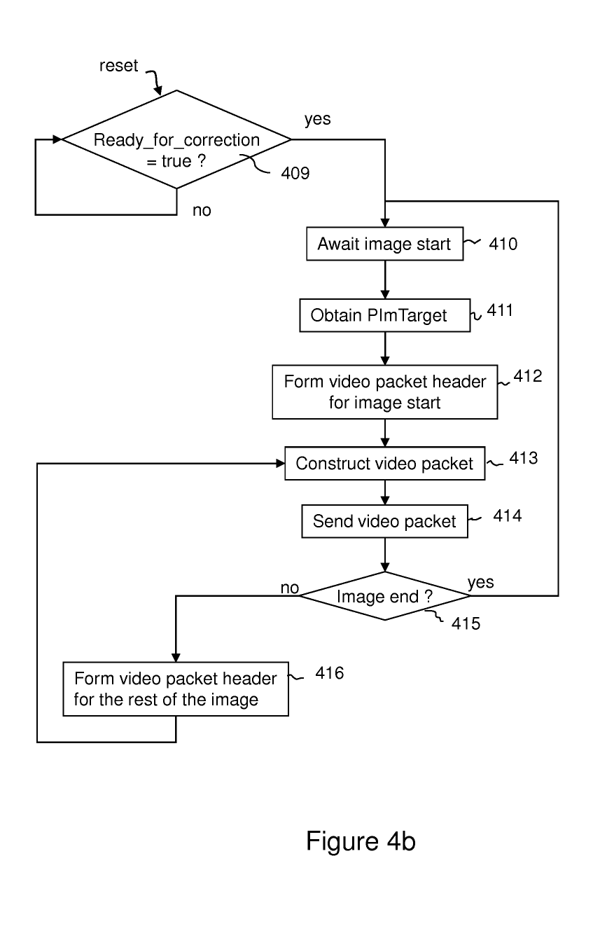

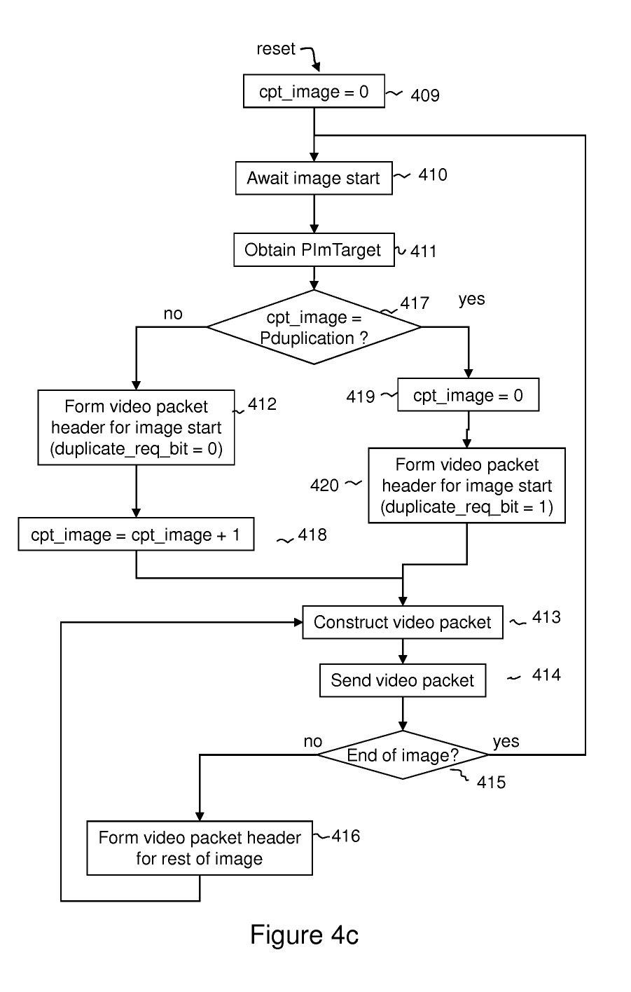

FIG. 4a illustrates a possible format for video data packets transmitted from a sending node 102 to a receiving node 103.

The video packet structure represented comprises a header 400 and a part containing useful data called payload 401.

The header 400 comprises several fields among which an indication of a start of image 402 (in particular a “start of image flag”, which is a predefined binary flag).

The information for this flag is provided by the module 216 of FIGS. 2 and 3 when that module constructs the first packet of an image.

The header 400 also comprises an optional field 403 for indicating the period setting the cadence of the images transmitted by the current node (PlmTarget or PlmSource depending on the embodiment). The information for this field is provided by the module 216 on construction of the first packet of an image. It is to be noted that this field is optional where the sending node performs the adaptation of the video data or determines and indicates at the very least the images to duplicate. As a matter of fact, in this case, the receiving device may know the value of the target frame period enabling the reading of the video data after adaptation, this knowledge resulting from the computations described earlier using the frame rates FlmSource and FlmAff received from the other nodes.

Where the sending node does not perform any operation (adaptation or determination of the images to duplicate) on the video data, that field 403 makes it possible to indicate the source frame rate to the receiving node, such that it can perform the adaptation (in particular compute the duplication period which depends on the source frame period).

The header 400 also comprises a first line number field 404.

This field 404 contains the number of the line of the transmitted image which corresponds to the first data 406 in the payload 401.

This field is defined by the module 216 on producing the payload 401.

The header 400 also comprises a last line number indicating field 405.

This field contains the number of the line of the transmitted image which corresponds to the last data 407 in the payload 401.

This field is defined by the module 216 on producing the payload 401.

The payload 401 contains the lines of the video stream or video data DATA which go from the first line represented in FIG. 4a by reference 406 (indicated by the field 404) to the last line represented by the reference 407 (indicated by the field 405).

It is to be noted that these lines of the video stream comprise information on the pixels to display by a display device.

In a particular embodiment described further below (in particular with reference to FIGS. 4c and 5d), in which the adaptation of the video data DATA for them to attain the target frame rate FlmTarget is carried out on the receiving nodes, the data packet may comprise an additional field 408, denoted “duplicate_req_bit”, indicating whether an image (corresponding to the useful data 401), is to be duplicated (field having the value “1” otherwise having the value “0”).

This field makes it possible for a sending node to indicate to a receiving node what the images are to be duplicated in order to perform the adaptation implemented in the invention.

This field is defined by the module 216 on producing the first packet corresponding to an image.

The optional field 403 may indicate the target frame period.

FIG. 4b is an algorithm executed by the video packet transmission module 216 of FIGS. 2 and 3 in a sending node device or 102, such as one of those represented in FIGS. 1a to 1c.

This algorithm comprises a succession of steps or instructions (portions of software code) which are executed by the module 216 in case data are sent to a receiving device or node, such as that referenced 103 in FIG. 1.

This transmission module 216 uses the video data read from the buffer memory 312. The management of this memory is described below with reference to FIGS. 11a and 11b, showing in particular that, in an embodiment of the invention, it is the module 216 which defines the period of reading of the video data with the objective of transmission, which period takes the value of the target frame period PlmTarget according to the invention.

The algorithm comprises an initial state 407 in which it is awaited for the correction parameters of FIG. 9 to be computed (i.e. for the “ready_for_correction” variable is equal to “true”).

In a step not represented that is executed after each starting up of the system, it is awaited for a complete image to be stored in the buffer memory 312, in order to ensure that there are sufficient data in the buffer memory 312 to maintain the reading throughput corresponding to the target frame period or target frame rate PlmTarget/FlmTarget.

Next, at step 410, the start of an image is awaited. The start of an image may be detected by the presence of a “start_image_bit” bit (described below with reference to FIG. 11a) and having the value 1.

When the start of a new image is detected, step 410 is followed by a step 411 during which an item of information on the duration PlmTarget is retrieved as described earlier.

During the following step 412, the header 400 (FIG. 4a) of the video packet including (in the optional field 403) the retrieved target frame period PlmTarget is constructed.

During the following step 413, the payload 401 of the video packet is constructed by concatenating several lines of video stream read from the memory 312. The number of video lines per packet is a result of the reading speed of the buffer memory 312 by the module 216, that is to say depends on the target frame rate FlmTarget.

During the following step 414, the video data packet so constructed is transmitted to the network controller part 207 of FIG. 2.

The following step 415 of FIG. 4b is a test making it possible to determine whether the end of the image concerned in the video stream has been reached or not.

It is considered that the end of the image is reached when all the lines of the image have been sent.

It should be noted that the number of lines per image depends on the video format used.

The information on the video format used is supplied to the processing CPU unit 201 by the HDMI receiving module 215 of FIGS. 2 and 3.

That unit 201 next supplies the video packet transmitting module 216 with the information on the number of lines per image of the video stream.

Where the end of the image concerned has not been reached (number of lines of the image not attained), step 415 is followed by a step 416.

During this step, a video data packet header is constructed.

This header is intended for a video packet which does not contain a start of image.

In this packet header, the optional indication of the period PlmTarget is not necessary since the first packet for the same image already indicates this value for the whole of the image, and the receiving node is capable of knowing this by its own means.

Step 416 is followed by step 413 already described during which the payload of a packet is constructed.

Where the end of the image has been reached (test of step 415), step 415 is followed by the step 410 already described of waiting for a new image.

FIGS. 11a and 11b illustrate management of the buffer memory 312. This management is useful in the embodiment in which the sending nodes 102 themselves perform the adaptation of the video data DATA by duplication of images in order for them to attain the target frame rate FlmTarget.

These algorithms each comprise a series of steps, instructions or portions of software code executed on executing the algorithm.

More particularly, FIG. 11a illustrates an algorithm for managing a pointer for writing in the buffer memory 312 of the video packet transmission module 216, at the sending nodes 102. The video data DATA received from the source 101 to which the current sending node is linked are stored, in that memory 312, in the form of entries E.

According to one implementation, each entry E of the buffer memory 312 comprises three fields. The first field E1 contains the video data; the second field E2 comprises the “start_image_bit” variable containing a bit having the value 1 if the video data of the entry are the first of a new image (0 otherwise); and the last field E3 contains the value of the period of the image PlmLocal that has just finished (value provided by the module 217—see reference 306 in FIG. 3) if the “start_image_bit” field has the value 1.

The size of the data supplied to the buffer memory at each writing clock cycle as described below is computed for the first data of an image to be aligned with an entry E in the memory.

During step 1100, the writing pointer, denoted “writing_ptr” is initialized to 0.

A rising edge of the writing clock is then awaited at step 1101.

At step 1102, the video data DATA received from the source 101 corresponding to the writing clock rising edge are written in memory at the address designated by the pointer writing_ptr. At this stage, the “start_image_bit” variable takes the value 0.

If the data of the writing clock rising edge correspond to the start of a new image (test 1103), the “start_image_bit” field is set to 1 at step 1104, and the value 306 of the period of the image that has just ended is written in the corresponding field, at step 1105.

It is to be noted that the start of a new image may be detected using the synchronization signals: when the signal Hsync indicates a new line and the signal Vsync indicates a new image.

If it is the start of the first image, a default value computed as nominal value is used. See in particular the value attributed to the register 516 at step 600 of FIG. 6a.

The writing pointer is next incremented modulo the number of entries in the memory during step 1106. As this memory is used in circular manner, it is checked during step 1107 that the writing pointer has not caught up with the reading pointer. Step 1101 may be then returned to.

FIG. 11b illustrates the management of the reading in the buffer memory 312, in particular at the time of the reading operations of FIG. 4b. This is in particular a matter of an algorithm for management of the reading pointer in the buffer memory 312 of the video packet transmission module 216 in the sending nodes.

During step 1150, a reading pointer, denoted “ptr_reading”, the object of which is to give the address of the next data to read, is initialized to 0.

Similarly, an image counter, denoted “cpt_image”, indicating the number of images sent over the network since the last image duplication is initialized to 0.

Lastly, a “ptr_im_to_duplicate” pointer indicating the address of the start of the next image to duplicate is initialized to 0.

It is next verified that the data are available in the buffer memory 312, at step 1161, by verifying that the reading pointer has not already met the writing pointer.

The data situated at the address indicated by ptr_reading are then read (step 1153) on arrival of a new rising edge of the reading clock (step 1152). It is to be noted that in case of adaptation by the sending node, the period indicated in the field E3 that is read is replaced by the target frame period PlmTarget on formation of the packets (if the optional field 403 has to be filled).

If the bit “start_image_bit” has the value 0 or if the current node is the reference node (i.e. Pduplication=0, no image duplication to do) (test 1154), the reading pointer ptr_reading is incremented (step 1159) before returning to step 1161 to process the following data.

If the bit “start_image_bit” has the value 1, the transmitted image counter is incremented (step 1155) then compared to the value “Pduplication+1” computed previously (+1 since the counter also counts the inserted image) (step 1156).

If the values are different, the pointer ptr_im_to_duplicate is updated to the value of the current reading pointer (step 1160). This makes it possible to store the last image in course of processing, for duplication of an image. To be precise, it is always sought to duplicate the last image transmitted so as not to create a visual artifact.

Next the reading pointer ptr_reading is incremented (step 1159) before returning to step 1161 to process the following data.

Lastly, if “cpt_image” is equal to “Pduplication+1”, the last transmitted image must be duplicated. For this, the “cpt_image” counter is reinitialized to 0 (step 1157 for the purpose of determining a following image to duplicate), then the “ptr_lecture” pointer takes (step 1158) the value of “ptr_im_to_duplicate” (as stored at the last step 1160), corresponding to the start of the image transmitted previously. Thus, the reading of the image situated at “ptr_im_to_duplicate” is again proceeded with.

Further to that step, step 1161 may be returned to in order to process the following data.

The various examples above show how a sending node 102 can determine a target frame rate common to all the devices of the network and adapt, by duplication of images, a source video stream in order for that stream to attain that target frame rate.

In a particular embodiment referred to previously, this adaptation is carried out at a receiving node 103 making it possible to reduce the use of the bandwidth (since the duplicated images are not sent twice over the network).

The buffer memory 312 is then no longer necessary at the sending nodes 102.

FIG. 4c illustrates the adaptation of the algorithm of FIG. 4b, to that particular embodiment. Steps 410 to 416 remain substantially unchanged.

However, the initialization step 409 provides for the initialization of the “cpt_image” counter to 0.

This algorithm also comprises a series of steps, instructions or portions of software code executed on executing the algorithm.

After step 411 of obtaining the period PlmTarget, the value of the counter cpt_image is tested at a test 417.

If it is different from the variable Pduplication (as described and computed previously with reference to FIGS. 9 and 10), a video packet header 400 is constructed (step 412) including, optionally, the value of the period PlmTarget obtained at step 411. This header also contains a “duplicate_req_bit” field taking the value “0” and indicating to the receiving node that the image in course is not to be duplicated on reception.

The counter cpt_image is then incremented (step 418), then processing continues at step 413, which is conducted in accordance with the description given earlier.

If the value of the counter cpt_image is equal to the variable Pduplication (the current image is thus to be duplicated), the cpt_image is reinitialized to 0 (step 419) and a video packet header is constructed including the value of the period PlmTarget obtained at step 411.

This header also contains a “duplicate_req_bit” field taking the value “1”, and indicating to the receiving node that the image in course will have to be duplicated on reception. Continuation is then made by step 413, which is conducted in accordance with the description given earlier.

Thus, by virtue of the “duplicate_req_bit” field, the receiving node is capable of adapting the video data, by duplication of images, to attain the determined target frame rate FlmTarget.

A description is now given of the display part 205 for a receiving node 103.

FIG. 5a represents the display sub-part 205 in detail. The display sub-part 205 is used by a receiving node or device 103 in order to extract the video sent by a sending node or device 102 and to display that extracted video on the display device 104. The display sub-part 205 comprises the module 214 in charge of the reception of the video packets and the module 213 in charge of generating the video control or synchronization signals as well as the associated stream of pixels. The packets and signals are next transmitted to the video interface module 212 (transmission module of HDMI type).

Module 214 comprises a module for reception from the network (“Rx from network”) 500 which is in charge of retrieving the synchronization data as presented in the packet headers 400 (FIG. 4a) and of sending those synchronization data to a “Vsync regen” module 504 of module 213. As a variant, those synchronization data (in particular FlmTarget) can be determined locally on the basis of the received FlmSource and FlmAff. Use of the field 403 is thus avoided.

Module 500 must also extract the video data as presented in the useful part 401 of the packets and store those extracted video data in a storage means “FIFO video” 501, of FIFO type. The detailed algorithm of the operation of the module 500 will be described with reference to FIG. 5c.

The module 213 comprises the “Vsync regen” module 504 already mentioned whose function is to progressively regenerate a signal, named “peer-vsync” 507 (this is a control signal synchronized to the target cadence FlmTarget).

The reconstitution of the vertical synchronization signal is made on the basis of the synchronization information received from the module 500. The “Vsync regen” module 504 has a limited capacity for a regeneration qualified as “soft” (for example no more than 10 pixels every 3 images). If the difference between the target vertical synchronization signal (that is to say corresponding to FlmTarget) and the regenerated synchronization signal “peer_vsync” 507 is greater than the “soft” synchronization capacity of the “Vsync Regen” module 504, the frequency of the signal of local pixel clock 514 is changed in the module 515 which generated it. The details for producing the “Vsync regen” module 504 are represented in FIGS. 5b and 6b.

The “peer_vsync” signal 507 (thus representing the target frame rate FlmTarget) is supplied by module 504 as input for a phase difference detection module (“phase detector”) 505. The other input to the detector 505 receives a “Vsync” signal 508 (vertical synchronization signal for the display FlmAff) supplied by a module 503 (“video synchro generator”).

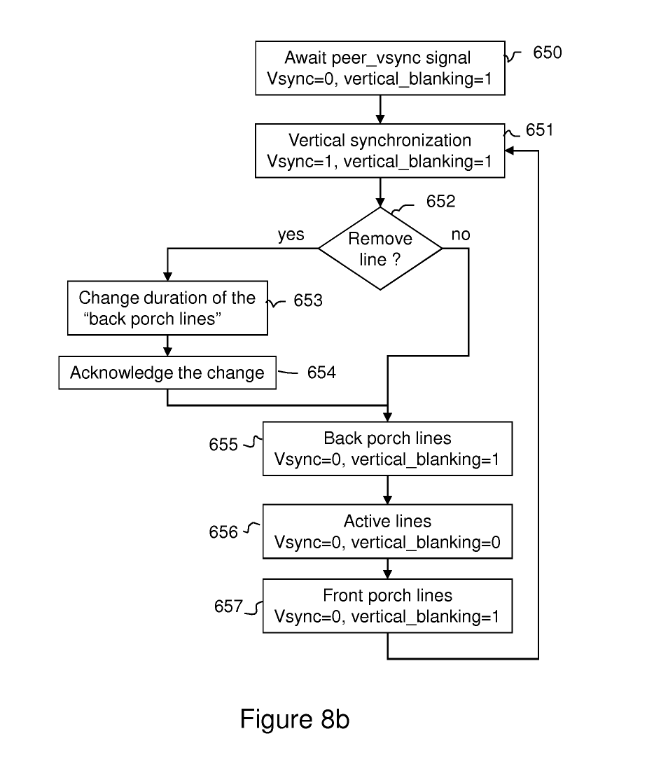

The video synchronization generation module 503 generates the video synchronization signals according to the signal of local pixel clock 514 and parameters representing the desired video format (number of pixels per line, number of lines per image, duration of the vertical and horizontal synchronization signals, etc.). These are the signals that the used at the HDMI interface 212 to control the synchronization of the display. The operation of this module as well as the details of the video format parameters are illustrated in FIGS. 8a, 8b and 8c. The video format parameters are stored by the CPU unit 201 in a RAM memory 502. The starting of the “video synchro generator” module 503 is synchronized on the first rising edge of the regenerated signal “peer_vsync” 507.

The detection module 505 computes the phase difference between the vertical synchronization signal of the receiving device or node 103, “Vsync” 508 (presenting the display frame rate FlmAff) and the vertical synchronization signal for the received video data, which is progressively reconstituted and represented by the “peer_vsync” signal 507. The implementation of a phase difference detection module is well known to the person skilled in the art and will therefore not be described in more detail here.

A drift manager 506 receives the phase difference information supplied by the module 505 and, depending on the nature of the difference or drift determined (positive, negative) and on the magnitude of the difference or drift identified (less than one line, more than one line), the module 506 activates the “remove_line” command 510 (to delete an inactive line of the image) destined for the video synchronization generation module 503 or triggers an “add line” warning transmitted over the network to the other nodes of the network. The use and the processing of that warning have been described earlier in relation to FIG. 10.

On reception of the acknowledgement of the “remove_line” command (“ack_change” 511) by module 503, module 506 sends module 504 a “realign” command 525 to realign the “peer_vsync” signal 507 with the line start. The details of the drift management module 506 are illustrated in FIG. 6a.

The “video synchro generator” module 503 acts on the duration of the vertical_blanking period of the image on reception of the “remove_line” command 510. The line or lines deleted at the start of the image to display depend, in terms of how many are deleted, on the magnitude of the difference or drift calculated previously. These lines are “invisible” on display and are qualified as inactive lines in that they do not contain information on the image pixels to display. The action of module 503 is situated in the period referred to as “Back porch lines” of an image. On reception of a “remove_line” command 510 the module 503 shortens the duration of the “Back porch lines” period 913 of an image. Once the command has been executed, module 503 sends module 506 the acknowledgement signal “ack_change” already referred to.

The module 212 transmits the video stream to the display device 104 on the basis of the “peer_vsync” signal 507 as supplied by the “Vsync_regen” module 504, signals “Hsync” 512 and “de” 513 as supplied by the module 503, the local pixel clock signal “pixel_clock” 514 and a pixel bus extracted from the storage means 501. The storage means 501 is read at the cadence of the “de” signal 513 which defines the times corresponding to the “active” pixels in the active lines of the image to display.

The module 515 for generating the signal of local pixel clock 514 (this signal providing the cadence/rhythm of the display period for the pixels) is for example composed of a quartz oscillator generating a frequency of 24 MHz, then a PLL with a ratio of 116/100, thus generating a clock at 27.84 MHz, then a multiplier enabling the pixel frequency to be attained as defined by the video format used (information contained in the RAM memory 502). Two other ratios may be used in addition to the 116/100, i.e. 117/100 and 115/100 in case the “soft” synchronization capacity of the “Vsync regen” module 504 is too limited.

Module 213 is full synchronous. This is because this module only depends on a single clock signal, i.e. the “pixel clock” signal of pixel clock 514. Other PLL-based implementations would depend on at least two clock signals, a local pixel clock such as clock 514 and a clock resulting from the PLL. The local pixel clock 514 may also be generated from a PLL in the module 515, but the signal of pixel clock 514 remains the sole clock source for all the other modules.

Furthermore, this implementation ensures soft phase modulation of the vertical synchronization signal “peer_vsync” 507 by the “Vsync Regen” module 504, thus avoiding an abrupt correction of the synchronization.

Furthermore, this implementation fully respects the integrity of the video data since the “video synchro generator” module 503 does not erase the inactive lines in the images to display.

Furthermore, this implementation does not alter the horizontal synchronization signal Hsync 512 in that the “video synchro generator” module 503 does not modify the duration of the active and inactive lines but only their number in an image.

FIG. 5b represents the “Vsync regen” module 504 in more detail. This module regenerates the vertical synchronization signal of the video data received by the receiving node or device 103 on the basis of the target frame rate/period. The latter is either retrieved from the headers of the packets received (extracted from the headers in the receiving node or device 103 by the “RX from network” module 500, then sent to the “Vsync regen” module 504), or is determined locally from the source and display frame rates received from the other nodes of the network.

The retrieved value PlmTarget is exploited by a “Vsync monitor” module 530 as described later with reference to FIGS. 8a, 8b and 8c

The “Vsync monitor” module 530 observes the period of the target vertical synchronization signal PlmTarget and controls the nominal duration of the regenerated signal “peer_vsync” 507 by changing the value of the “nominal Vsync” register 516 depending on the change in that period PlmTarget.

A counter 517 supplied by the signal of pixel clock 514 is compared to the “nominal vsync” register 516 by a comparator 518. Each time the counter attains the nominal value of the vertical synchronization period, the comparator 518 generates an impulse destined for a “Vsync high level” module 522 and for the reset-to-zero command for the counter 517.

The “Vsync high level” module 522 maintains the “peer_vsync” signal 507 in the high state for a duration defined by the video format used. This information is contained in the RAM memory 502.

A network time module 519 generates a time stamp in relation with the network clock and as is supplied by the network controller part 207. At each rising edge of the “peer_vsync” signal 507, the module 519 generates a time stamp and sends it to the “Vsync monitor” module 530.

The “nominal Vsync” register 516 may also receive a realign command 525 sent by the drift management module 506 (FIG. 5a). This command comprises a cycle time and a ‘+’ or ‘−’ sign. On reception of a − sign, the “nominal Vsync” register 516 increases its value by adding to it the difference between its own value and the cycle time included in the command. On reception of a + sign, the “nominal Vsync” register 516 reduces its value by taking from it the difference between its own value and the cycle time included in the command

FIG. 5c illustrates an algorithm executed by the module 500 of FIG. 5a (receiving node or device 103), in particular to supply module 530, from module 504, with the target frame period indication when this information is given in the packets received (field 403).

This algorithm comprises a succession of steps, instructions or portions of software code which are executed on executing the algorithm.

The algorithm comprises a first step 700 of awaiting reception of a video data packet from the network controller part 207 of FIG. 2.

As soon as a packet is received the following step 701 is executed.

During this step, a test is carried out in order to determine whether the header of the packet contains a start of image flag (flag 402 of FIG. 4a).

In case of negative response, step 700 is again executed.

In the opposite case (start of image), a following step 702 is executed.

During this step, the value contained in field 403 (current PlmTarget) is extracted from the header 401 of the packet and the following step 703 is executed.

During this step, the extracted value PlmTarget is transmitted to the “Vsync monitor” module 530 of FIG. 5b and the following step 704 is executed.

During this step, the active lines of the video stream of the payload part 401 of the packet of FIG. 4a are stored in the storage means 501 of FIG. 5a and the following step 705 is executed.

During this step, a test is carried out in order to determine whether an image end has been reached.

The end of an image is reached when all the lines of the image have been stored.

As already indicated above, the number of lines per image depends on the video format used and this information is sent by the HDMI receiving module 215 of FIG. 2 to the processing CPU unit 201 of the sending node or device 102.

The CPU unit 201 of the sending node or device 102 transmits that information to the receiving node or device 103, more particularly to the CPU unit 201 thereof, through the intermediary of control data from the network controller part 207.

The CPU unit 201 of the receiving node or device sends an item of information on the number of lines per image of the video or module 500 of FIG. 5a.

Assuming that the end of an image has not been reached, step 705 is followed by a step 706 of waiting for a next video packet (of the same image) coming from the network controller part 207.

In case of packet reception, step 706 is followed by step 704 already described.

Assuming that the end of an image has been reached, step 705 is then followed by the step 700 already described above.

This algorithm applies in particular when the adaptation of the video data DATA, by duplication of images, is carried out at the sending nodes 102.

In the particular case in which this adaptation is carried out on the receiving nodes (as discussed previously in relation with FIG. 4c), these latter take into account possible indications for duplication of images inserted in the header of the packets by the sending nodes (see field 408 comprising the “duplicate_req_bit” variable), as now described with reference to FIG. 5d.

The algorithm of this Figure comprises a series of steps, instructions or portions of software code executed on executing the algorithm.

In this Figure, steps 700 to 706 are similar to those of FIG. 5c.

Further to steps 700 to 703, a step 707 is provided during which the value of the “duplicate_req_bit” variable is extracted from the header of the received packet.

The video data (video lines) are then stored in the storage means 501 during step 704.

It is then tested (step 708) whether the “duplicate_req_bit” variable has the value “1”. If that is the case, the image in course of reception must be duplicated. For this, the video data of that image are stored in parallel in a second storage means, of temporary memory type (step 709).

Further to step 709 or in case variable “duplicate_req_bit” has the value “0”, the test 705 described earlier is proceeded to. Step 706 is executed if the received packet does not correspond to the end of the current image.

After reception of the last packet corresponding to the image in course (test 705) and if “duplicate_req_bit” has the value “1” (test 710), the value of the period (or duration) of the image that has just ended, that is to say PlmTarget, is forwarded to module 530 (step 711).

The video data corresponding to the image that has just ended are then forwarded from the second storage means to the storage means 501, during step 712. This step provides for the actual duplication of the image within the video data.

If the image is not to be duplicated or further to step 712, step 700 is returned to in order to continue the processing of the following video packets.

As illustrated here, the indication for duplicating images provided for the receiving node 103 by the sending node 102 is integrated into the header of the video transport packets.

However, as a variant, this indication may be transmitted in parallel with the video transport packets (in the form of image insertion request packets), on the same communication network or via specific links.

Also, although in the present example, the images to duplicate are determined by the sending node 102, this determination may be carried out in a variant by the receiving node 103. In this case, the sending node 102 only participates in the processing operations according to the invention to transmit its source frame rate FlmLocal (or corresponding PlmLocal) as described above. Furthermore, the receiving node itself determines the target frame rate.

To be precise, in this case, as all the nodes of the network share their values of period PlmLocal with each other, they all possess all the necessary elements for the computation of the correction parameters, i.e. the target frame rate (or period) FlmTarget and the duplication period Pduplication corresponding to a source.

The receiving nodes 103 may thus by themselves employ and manage the value of the “cpt_image” counter as described earlier (on behalf of the sending nodes).

The sending nodes then no longer need to send any image duplication request. Moreover, the value of the “Pduplication” variable is updated, by the receiving node, at the time of the monitoring in FIG. 10 or on switching with another sending node (since in this case the receiver receives another stream with another source frame rate).

FIG. 6a illustrates an algorithm executed by the “Vsync monitor” module 530 of FIG. 5b (receiving node or device 103).

This algorithm comprises a series of steps, instructions or portions of software code executed on executing the algorithm.

This algorithm comprises a first step 600 during which the register 516 is initially loaded with a nominal value by default representing the target frame rate expressed according to the signal of local pixel clock 514 (this means that the nominal value so loaded is equal to the number of pixels per image, including the blanking periods).

This value is set by the CPU unit 201 and stored in the RAM memory 502.

By way of example, for a video format of 1080 pixels using a frequency of 60 Hz, the nominal value of the register 516 is set to 2 475 000, corresponding to 2200 (pixels per line)×1125 (lines per image).

During the following step 601, an item of information relative to the target frame period of the received video data is awaited from the module 500 of FIG. 5a. As indicated previously, this is the period PlmTarget which is either given in the header of the first data packet of the current image, or is determined by the receiving node itself.

On reception of this PlmTarget information, step 601 is followed by step 602.

During that step, the counter 517 of FIG. 5b starts, incremented in accordance with the cadence 514 of the pixel clock 515.

The counter 507 is thus synchronized with the start of an image.

During this step, a variable denoted “local V1” is set to the value of the network time (network clock).

Step 602 is next followed by a step 604 of awaiting the occurrence of a local time stamp triggered by the “peer_vsync” signal 507. In practice, when this signal 507 rises (rising edge), the value of the local time stamp takes the value of the network time 519.

The network time 519 is driven by the controller part of the network 207.

Step 604 is then followed by a test step 605 in order to determine whether the vertical synchronization signal Vsync corresponding to the target frame rate FlmTarget is slower than the “peer_vsync” signal 507. This is a simple comparison of signal period.

In order to perform this test, the period PlmTarget obtained is compared with [local time stamp value−local V1].

If the first value (PlmTarget) is (strictly) greater than the second value, the signal Vsync cadencing the received video data is slower and step 609 is executed to reduce the speed of the “peer_vsync” signal 507.

In the opposite case, step 605 is followed by step 607.

During step 609, a test is carried out in order to determine whether soft application of the synchronization correction is possible.

The correction capability of the module may for example be limited to a predetermined number K of pixels every N cycles.

Thus, if the last correction occurred before the elapse of N cycles (for example three cycles), step 609 is then followed by the step 604 already described and no correction to the “peer_vsync” signal 507 is applied.

On the other hand, if the quantity or magnitude of the correction (PlmTarget−[local time stamp value−local V1]) is (in absolute value) greater than the number of pixels K (for example ten pixel clock cycles), then a signal of change in the “local pixels clock ratio” is sent from the module 504 to the module 515 (“coarse_correction” 523 in FIG. 5a) to modify the pixel clock 514. Thus, the speed of the pixel clock generated by the module 515 will be modified to be closer to the target frame rate FlmTarget. In the aforementioned case the correction capability of K pixels per N cycles is exceeded and the requested correction is considered as “abrupt”.

Despite this adjustment of the pixel clock, step 609 is then followed by step 604 already described and no correction is applied.

In the opposite case, step 609 is followed by step 606.

During step 606, the “peer_vsync” signal 507 is slowed by a number of clock cycles (of the signal of local pixel clock 514) as determined at step 609.

More particularly, the signal 507 is slowed by correspondingly activating a command 520 for decrementation of the register 516 (FIG. 5b).

Next, the “local V1” variable is updated to take the current local time stamp value.

Step 606 is then followed by step 604 already described for the purpose of awaiting a new local time stamp triggered by the “peer_vsync” signal 507 and a new period PlmTarget obtained by a new first image packet received or determined by the receiving node for a new image.

Returning to step 605, in case of negative test, this step is followed by the step 607.

During this step, a test is carried out in order to know whether the vertical synchronization signal Vsync corresponding to current PlmTarget is faster than the “peer_vsync” signal 507.

For the implementation of this test, the comparison is made between the period PlmTarget obtained and [local time stamp value−local V1].

If the first value (PlmTarget) is (strictly) greater than the second value, then the signal Vsync is faster and step 607 is followed by test step 610.

In the opposite case, the variable local V1 is updated to take the current local time stamp value.

Step 607 is then followed by step 604 already described above.

Returning to step 610, a test is carried out in order to determine whether soft application of the synchronization correction is possible (that is to say non-abrupt).

As already described, the correction capability of this module is limited to a number K of pixels every N cycles.

Thus, if the last correction happened before the elapse of N cycles (for example three cycles), step 610 is followed by the step 604 already described and no correction is applied.

If the quantity or magnitude of the correction (PlmTarget−[local time stamp value−local V1]) is (in absolute value) greater than the number K (for example ten pixel clock cycles), then a “local pixels clock ratio” change signal is sent by the module 504 to the module 515 of FIG. 5a (“coarse_correction” 523) and step 610 is then followed by the step 604 already described without any correction being applied.

In the opposite case, step 610 is followed by a step 608 during which the “peer_vsync” signal is accelerated by a number of cycles of the local pixel clock 514 as defined at step 609.

The acceleration of the signal is obtained more particularly by correspondingly activating a command 521 for incrementing the nominal register 516 of FIG. 5b.

Next, the variable local V1 is updated to take the current local time stamp value.

Step 608 is then followed by the step 604 already described for the purpose of awaiting a new period PlmTarget obtained by a new received first image packet (or determined by the receiving node).

By virtue of these mechanisms implemented in the module 530, the “peer_vsync” signal 507 is synchronized on the target frame period/rate defined by the video data.

FIG. 6b describes an algorithm implemented by the drift management module 506 of FIG. 5a to track a drift between that “peer_vsync” signal 507 and the synchronization signal for the display (that is to say corresponding to FlmAff) specific to the video synchronization generator 503.

This module is implemented by the receiving node or device 103 to command the deletion of inactive lines by the “video synchro generator” module 503 of FIG. 5a. The adaptation of the number of inactive lines in an image is carried out according to the phase shift (or drift) determined by the detection module 505 on the signals “Vsync” 508 and “peer_vsync” 507. The “Vsync” signal 508 is generated by the “video synchro generator” module 503 and thus represents the display frame rate FlmAff supplied to the display device 104. The “peer_vsync” signal 507 is generated by the “Vsync regen” module 504 on the basis of the information representing the target frame rate, as disclosed previously.

At the initial step 620 of the algorithm, the module puts itself on standby for a detection of phase difference (or drift) computed by the “phase detector” module 505. Next, when a phase difference is detected, the module 506 passes to the following step 621.

At step 621 the module 506 determines, via a test, the direction of the phase shift which was determined by the “phase detector” module 505. If the “peer_vsync” signal 507 is ahead in phase relative to the “Vsync” signal 508, then the module passes to the step 622, otherwise the “Vsync” signal 508 is ahead in phase relative to the “peer_vsync” signal 507 and the module passes to step 627.

At step 622, the module 506 determines by a test whether the phase difference (or drift) has attained or exceeded the value of a line. The value of a line is supplied by the CPU unit or obtained on the basis of the RAM memory 502. For example, for a video format of 1080 pixels, the value of a line corresponds to 2200 pixel clock rising edges 514. Thus, if the phase difference is equal to or greater than the value of a line, the module 506 passes to step 623, otherwise it loops back to step 620 already described.

At step 623, the module 506 activates the “remove_line” command 510 in order to reduce the display frame period PlmAff of the “Vsync” signal 508 which is lagging in phase relative to the “peer_vsync” signal 507 corresponding to the target frame period PlmTarget. Module 506 next passes to step 624.

At step 624, the module 506 puts itself on standby for the acknowledgement signal “ack_change” 511 which will be sent by the “video synchro generator” module 503 as soon as the command made has been taken into account. Once the acknowledgement signal has been received, module 506 proceeds to step 625.

At step 625, the module 506 releases the commands that have been made, then sends a “realign” command 525 to realign the “peer_vsync” signal 507 on the start of line. The realignment value is for example equal to the difference in the cycle time between the “Vsync” signal 508 and the “peer_vsync” signal 507. The cycle time of the “Vsync” signal 508 is contained in the RAM memory 502 and the cycle time of the “peer_vsync” signal is known to the “Vsync regen” module 504. If the acknowledged signal is “remove_line” 510 (FIG. 5a), the realignment command includes the ‘+’ indication and the cycle time of the “Vsync” signal 508 contained in the RAM memory 502. Next, the module 506 loops back to the initial step 620 already described.

Returning to step 627, the module 506 triggers the sending of an “add line” warning message to all the other nodes of the network. More particularly, it is possible to be in this situation only if the “Vsync” signal 508 generated by the current receiving node 103 has become faster than the target synchronization signal cadencing the received video data. This means that the receiving node has a display frame rate higher than the reference frame rate (by definition the highest of the FlmLocal). The warning message thus makes it possible to update the target frame rate in each node of the network.

The module then passes to the step 628 at which the “warning_ack” variable takes the value 0, then at step 629 it is awaited for this variable to be reset to 1 by the CPU, indicating the taking into account of the warning and the updating of the correction parameters on the network.

Step 620 is then looped back to.

FIGS. 8a, 8b and 8c illustrate the operation of the “video synchro generator” module 503 of FIG. 5a which implements three algorithms in parallel.

These algorithms each comprise a series of steps, instructions or portions of software code executed on executing the algorithm.

A first algorithm illustrated in FIG. 8a is for generating the “Hsync” signal 512 and an internal horizontal blanking signal taken into account by the algorithm of FIG. 8c for the generation of the “de” signal 513.

At the initial step 640 of the algorithm the module 503 puts itself on standby for a rising edge of the “peer_vsync” signal 507 in order to synchronize its commencement with that signal. At this step the “Hsync” signal 512 is kept in the low state and the “horizontal_blanking” signal is kept in the high state. On detection of a rising edge of the “peer_vsync” signal 507 the module 503 proceeds to the following step 641.

At step 641, the module 503 goes into horizontal synchronization phase. At this step the “Hsync” signal 512 is kept in a high state and the “horizontal_blanking” signal is kept in a high state. The duration of this state depends on the image format contained in the RAM memory 502 which is, for example, 44 edges of the pixel clock signal 514 for a 1080p video format at 60 Hz. At the end of this period the module 503 proceeds to the following step 642.

At step 642, the module 503 enters the “Back porch pixels” period. At this step the “Hsync” signal 512 is kept in a low state and the “horizontal_blanking” signal is kept in a high state. The duration of this state depends on the image format as stored in the RAM memory 502. This duration is for example 148 signal edges of pixel clock 514 for a 1080p video format at 60 Hz. At the end of this period the module 503 proceeds to the following step 643.

At step 643, the module 503 enters into display phase for the “active” pixels of an active line of an image. At this step the “Hsync” signal 512 is kept in a low state as is the “horizontal_blanking” signal. The duration of this state depends on the image format as stored in the RAM memory 502. This duration is for example 1920 signal edges of pixel clock 514 for a 1080p video format at 60 Hz. At the end of this period the module 503 proceeds to the following step 644.

At step 644, the module 503 enters the “Front porch pixels” period. At this step the “Hsync” signal 512 is kept in a low state and the “horizontal_blanking” signal is kept in a high state. The duration of this period or state depends on the image format as stored in the RAM memory 502. This duration is for example 88 signal edges of pixel clock 514 for a 1080p video format at 60 Hz. At the end of this period the module 503 returns to step 641 already described.

The steps 641, 642 and 644 correspond to the “horizontal_blanking” period during which the pixels are “inactive” (no display of pixels). Step 643 corresponds to the period in which the pixels of a line are “active”, that is to say that their display is proceeded to in accordance with the cadence of the local pixel clock, that is to say at the display frame rate FlmAff which, by virtue of the means described previously, should be equal to FlmTarget.

A second algorithm illustrated in FIG. 8b is for generating the “Vsync” signal 508 of FIG. 5a and a vertical blanking internal signal (“vertical_blanking”) taken into account by the algorithm of FIG. 8c for the generation of the “de” signal 513. This algorithm is furthermore in charge of the management of the “remove_line” command 510 of FIG. 5a.

At the initial step 650 of the algorithm, the module 503 puts itself on standby for a rising edge of the “peer_vsync” signal 507 in order to synchronize its commencement with that signal. At this step the “Vsync” signal 508 is kept in a low state and the “vertical_blanking” signal is kept in a high state. On detection of a rising edge of the “peer_vsync” signal 507 the module 503 proceeds to the following step 651.

At the step 651, the module 503 enters a period or phase of vertical synchronization. At this step the “Vsync” signal 508 is kept in a high state, as is the “vertical_blanking” signal. The duration of this state depends on the image format as known from the RAM memory 502. This duration is for example 5 lines for a 1080p video format at 60 Hz. At the end of this period the module 503 proceeds to the following step 652.

At step 652, the module performs a test in order to determine whether it has received a “remove_line” command 510 from the drift manager 506 (FIG. 5a). If it has received such a command, it proceeds to the following step 653. Otherwise, it proceeds to the following step 655.

At step 653 the module 503 modifies the duration of the “Back porch lines” period to come. This new duration depends on the command received and is adapted to the drift between the “Vsync” and “peer_vsync” signals. The duration of the “Back porch lines” period depends on the image format contained in the RAM memory 502 and is, for example, 36 lines for a 1080p format at 60 Hz. On reception of a “remove_line” command 510, the duration of the “Back porch lines” period is decremented by one unit to pass to 35 lines for example. This new value is not stored in the RAM memory 502. Module 503 next passes to step 654.

At step 654, the module 503 sends an acknowledgement signal “ack_change” to the drift management module 506. Module 503 next passes to step 655.

At step 655, the module 503 enters the “Back porch lines” period. At this step the “Vsync” signal 508 is kept in a low state and the “vertical_blanking” signal 910 is kept in a high state. If the transition to this state comes directly from step 652, the duration of this state depends on the image format known from the RAM memory 502. The duration is for example 36 lines for a 1080p video format at 60 Hz. If the transition to this state comes from steps 653 and 654 the duration of this state depends on the computation carried out at step 653 and is, for example, 35 lines. At the end of this period the module 503 proceeds to the following step 656.

At the step 656, the module 503 enters a phase or period of display of active lines. At this step the “Vsync” signal 508 is kept in a low state as is the “vertical_blanking” signal. The duration of this state depends on the image format known from the RAM memory 502. This duration is for example 1080 lines for a 1080p video format at 60 Hz. At the end of this period the module 503 proceeds to the following step 657.

At step 657, the module 503 enters a “Front porch lines” period. At this step the “Vsync” signal 508 is kept in a low state and the “vertical_blanking” signal is kept in a high state. The duration of this state depends on the image format known from the RAM memory 502. This duration is for example 5 lines for a 1080p video format at 60 Hz. At the end of this period the module 503 proceeds back to step 651 already described.

The steps 651, 655 and 657 correspond to the “vertical_blanking” period during which the lines are “inactive” (no display of lines). Step 656 corresponds to the “Active lines” period during which the lines are active, that is to say that their display can be proceeded to.

A third algorithm illustrated in FIG. 8c is for generating the “de” signal 513. This algorithm is constituted by a single step 660 executed continually and which sets the “de” signal 513 of FIG. 5a to the high state when both the “horizontal_blanking” and “vertical_blanking” signals are themselves in the high state. Otherwise, if one of the two “horizontal_blanking” or “vertical_blanking” signals is positioned in the low state, then the “de” signal 513 is itself set to the low state.

The preceding examples are only embodiments of the invention which is not limited thereto.

For example, although the synchronization according to the invention is based on the vertical synchronization signal Vsync, it may be performed on another synchronization signal or even without being based on the synchronization signals supplied by the sources.

Furthermore, the above mechanisms envision the generation of an “add line” warning if the Vsync signal 508 of the receiving node or device 103 lags (is slower) than the signal of the received data represented by “add line” 507. This warning is based on the fact that it is desired for the target frame rate FlmTarget to be the highest of the frame rates FlmLocal specific to the nodes 102, 103 of the network.

However, in case it is envisioned for the target frame rate FlmTarget to be the highest of uniquely the FlmSource source frame rates, the display frame rate of a receiving node 103 (corresponding to Vsync 508) may be higher than the target frame rate FlmTarget (corresponding to “peer_vsync” 507). In this case, the video synchronization generator module 503 can implement line adding commands (in which case, no “add line” warning is issued) in order to compensate for a positive drift of the synchronization and display signal. The adding mechanisms are substantially symmetrical to the remove line mechanisms.

1. A method of synchronization between devices of a distribution system for distributing video streams of images comprising, linked to a communication network, at least three sending or receiving devices, including a sending device and a receiving device,
a sending device being configured to receive, from a source, a source video stream having a frame rate, referred to as source frame rate,
a receiving device being configured to control the display, at a display cadence, referred to as display frame rate, of a video stream on a display device to which it is connected,
which method is characterized in that it comprises the steps of:
obtaining a frame rate, referred to as target frame rate, which is common for the devices,
adapting, by each device of the set of sending devices or of the set of receiving devices, a source video stream received from a source, respectively, directly or via a sending device, from the source frame rate to the target frame rate,
adjusting, at each receiving device, the display frame rate to the target frame rate so as to control a display at said target frame rate.

2. A synchronization method according to claim 1, wherein the step of obtaining the target frame rate comprises a step of determining a reference frame rate from among only the source frame rates.

3. A synchronization method according to claim 1, wherein the step of obtaining the target frame rate comprises a step of determining a reference frame rate from among the source frame rates and the display frame rates.

4. A synchronization method according to claim 2, wherein the reference frame rate is the highest frame rate from among the source and display frame rates taken into account.

5. A synchronization method according to claim 4, wherein said target frame rate is equal to the reference frame rate if the latter is a source frame rate, and is strictly greater than the reference frame rate if the latter is a display frame rate.

6. A synchronization method according to claim 1, wherein each device determines its own source or display frame rate and transmits, to the other devices, the determined frame rate together with an item of information on the type of device, sending or receiving, from which the transmitted frame rate comes.

7. A method according to claim 6, wherein the determining of a device's own frame rate is made by determining a period of a synchronization signal of said device relative to a common network clock of the communication network.

8. A method according to claim 7, characterized in that the step of obtaining the target frame rate is carried out on each device having received the values of synchronization signal period from the other devices of the network, by determining a reference frame rate on the basis of said received synchronization signal period values.

9. A synchronization method according to claim 6, wherein:
the determining, by the devices, of their own source or display frame rates,
the transmitting of those frame rates to the other devices, and
the obtaining, by each device having received the frame rates of the other devices, of the target frame rate by determining a reference frame rate on
the basis of the source or display frame rates received, are carried out periodically by said devices.

10. A synchronization method according to claim 1, wherein the adapting of the source video stream comprises duplicating at least one image in order for the video stream to attain said target frame rate.

11. A synchronization method according to claim 10, wherein the duplicating comprises a step of computing a drift between the source frame rate and the target frame rate, and wherein the number of images to duplicate is a function of the computed drift to attain the target frame rate.

12. A synchronization method according to claim 1, wherein the adapting of the source video stream is carried out by each receiving device receiving a source video stream that has a source frame rate less than the target frame rate.

13. A synchronization method according to claim 12, wherein the adapting of the source video stream comprises duplicating at least one image in order for the video stream to attain said target frame rate, and wherein said receiving device determines, on the basis of the target frame rate and the frame rate of said received source video stream, the images to duplicate in said video stream.

14. A synchronization method according to claim 12, wherein the adapting of the source video stream comprises duplicating at least one image in order for the video stream to attain said target frame rate, and wherein said sending device determines the images to duplicate in said video stream and indicates them to a receiving device of said source video stream.

15. A synchronization method according to claim 14, wherein said images to duplicate are signaled in the header of packets carrying the video stream.

16. A synchronization method according to claim 1, wherein the adapting of the source video stream is carried out by each sending device receiving a source video stream having a source frame rate less than the target frame rate.

17. A synchronization method according to claim 16, wherein the adapting of the source video stream by a sending device is carried out by reading, at said target frame rate, a buffer memory storing said source video stream.

18. A synchronization method according to claim 1, wherein the adjusting of the display frame rate of a receiving device comprises a step of synchronizing by closed-loop control of the receiving device to compensate for a drift between the display frame rate and the target frame rate.

19. A synchronization method according to claim 18, comprising:
detecting, by the receiving device, a positive drift representing a higher display frame rate than the target frame rate;
sending a warning signal to the other devices by the receiving device in response to the detection of a positive drift; and
updating the target frame rate by the devices in response to the warning signal.

20. A synchronization method according to claim 19, wherein the updating of the target frame rate comprises:
determining, by the devices, of their own source or display frame rates,
transmitting those frame rates to the other devices, and
obtaining, by each device having received the frame rates of the other devices, of the target frame rate by determining a reference frame rate on the basis of the source or display frame rates received.

21. A synchronization method according to claim 19, wherein the adapting of the source video stream comprises duplicating images at a duplication cadence in order for the video stream to attain said target frame rate, and the duplication cadence is updated upon detecting the warning signal.

22. A method according to claim 18, wherein the adjusting of the display frame rate of a receiving device receiving a video stream comprises deleting or adding at least one image line in an inactive part of an image of the video stream, so as to artificially modify the display frame rate on the receiving device.

23. A method according to claim 18, comprising a step of re-adjusting a pixel clock of the receiving device when a negative drift representing a target frame rate, regenerated by the receiving device and lower than the target frame rate, is detected as being higher, in absolute value, than a threshold value.

24. An image video stream distribution system comprising, linked to a communication network, at least three sending or receiving devices, including a sending device and a receiving device, taken from
a sending device configured to receive, from a source, a source video stream having a frame rate, referred to as source frame rate,
a receiving device configured to control the display, at a display cadence, referred to as display frame rate, of a video stream on a display device to which it is connected,
which system is characterized in that it comprises a means for obtaining a frame rate, referred to as target frame rate, which is common for the devices,
and wherein
each device of the set of sending devices or of the set of receiving devices, comprises means for adapting a source video stream received from a source, respectively, directly or via a sending device, from the source frame rate to the target frame rate,
and each receiving device comprises a means for adjusting its own display frame rate to the target frame rate so as to control a display at said target frame rate.

25. A video stream sending or receiving device within a communication network comprising at least three sending or receiving devices, including a sending device and a receiving device, characterized in that it comprises:
means for receiving own frame rates from the other devices of the network;
a means for obtaining a common frame rate, referred to as target frame rate, by determining a reference frame rate on the basis of the received frame rates and on the basis of a frame rate local to said device defining a transmission frame rate for transmitting a video stream to a downstream device,
means configured to adjust the local frame rate to the target frame rate so as to transmit, at said target frame rate and to the downstream device, a received video stream.

26. A device according to claim 25, further comprising:
a means for determining a period of a synchronization signal of the device relative to a common network clock so as to obtain said frame rate local to the device,
means for transmitting, to the other devices of the network, the value of the determined synchronization signal period and an item of information on the type of device, sending or receiving, from which comes the transmitted value.

27. A device according to claim 25, comprising a buffer memory for storing data of said video stream, and configured to write or read to or from said buffer memory at said target frame rate.

28. A means of information storage, readable by a computer system, comprising instructions for a computer program adapted to implement the method according to claim 1, when the program is loaded and executed by the computer system.

29. A computer program product that can be loaded into a computer system, said program comprising instructions enabling the implementation of the synchronization method according to claim 1, when that program is loaded and executed by a computer system.
